(19) United States
(12) Patent Application Publication
(10) Pub. No.: US 2022/0198432 A1
(43) Pub. Date: Jun. 23, 2022

(54) REAL-TIME DETERMINATION OF TARGETED BEHAVIORAL DATA BASED ON DECOMPOSED STRUCTURED MESSAGING DATA

(71) Applicant: The Toronto-Dominion Bank, Toronto (CA)

(72) Inventors: Christopher Mark JONES, Villanova, PA (US); Barry Wayne BAIRD, JR., Kennett Square, PA (US); Claude Bernell LAWRENCE, JR., Philadelphia, PA (US); Jonathan Joseph PRENDERGAST, West Chester, PA (US)

(21) Appl. No.: 17/553,627

(22) Filed: Dec. 16, 2021

Related U.S. Application Data
(60) Provisional application No. 63/128,028, filed on Dec. 19, 2020.

(51) Int. Cl. G06Q 20/32

(52) U.S. Cl. CPC G06Q 20/3255; G06Q 20/322

(57) ABSTRACT

The disclosed embodiments include computer-implemented systems and processes that provision targeted behavioral data based on structured messaging data. For example, an apparatus may obtain elements of decomposed message data that characterize real-time payments associated with a counterparty during a first temporal interval. Based on the elements of decomposed message data, the apparatus may determine a value of a plurality of parameters that characterize the counterparty during the first temporal interval. Further, and based on the elements of decomposed message data and on the parameter values, the apparatus may generate output data indicative of a likelihood of an occurrence of an event during the first temporal interval or a second temporal interval. The apparatus may also transmit notification data to a device operable by the counterparty. The notification data may cause an application program executed at the device to present the portion of the output data within a digital interface.

### CROSS-REFERENCE TO RELATED APPLICATION

This application claims the benefit of priority to U.S. Provisional Patent Application No. 63/128,028, filed on Dec. 19, 2020, the entire disclosure of which is expressly incorporated herein by reference to its entirety.

### TECHNICAL FIELD

The disclosed embodiments generally relate to computer-implemented systems and processes that determine and provision, in real-time, targeted behavioral data based on decomposed, structured messaging data.

### BACKGROUND

Today, the mass adoption of smart phones and digital payments within the global marketplace drives an increasingly rapid adoption of real-time payment (RTP) technologies by financial institutions, consumers, vendors and merchants, and other participants in the payment ecosystem. RTP technologies emphasize data, messaging, and global interoperability and in contrast to many payment rails, such as those that support credit card payments, embrace the near ubiquity of mobile technologies in daily life.

### SUMMARY

In some examples, an apparatus includes a communications interface, a memory storing instructions, and at least one processor coupled to the communications interface and to the memory. The at least one processor is configured to execute the instructions to obtain first elements of decomposed message data. The first elements of decomposed message data are associated with exchanges of data involving a first counterparty, and characterize real-time payments requested by or from the first counterparty during a first temporal interval. Based on the first elements of decomposed message data, the at least one processor is also configured to execute the instructions to determine a value of a plurality of parameters that characterize the first counterparty during the first temporal interval. Further, and based on the first elements of decomposed message data and on the parameter values, the at least one processor is configured to execute the instructions to generate output data indicative of a likelihood of an occurrence of an event during at least one of the first temporal interval or a second temporal interval. The at least one processor is also configured to execute the instructions to transmit, via the communications interface, notification data to a device operable by the first counterparty. The notification data includes at least a portion of the output data. Further, the notification data causes an application program executed at the device to present the portion of the output data within a digital interface.

In other examples, a computer-implemented method includes obtaining first elements of decomposed message data using at least one processor. The first elements of decomposed message data are associated with exchanges of data involving a first counterparty, and characterize real-time payments requested by or from the first counterparty during a first temporal interval. Based on the first elements of decomposed message data, the computer-implemented method also includes determining, using the at least one processor, a value of a plurality of parameters that characterize the first counterparty during the first temporal interval. Further, and based on the first elements of decomposed message data and on the parameter values, the computer-implemented method includes generating, using the at least one processor, output data indicative of a likelihood of an occurrence of an event during at least one of the first temporal interval or a second temporal interval. The computer-implemented method also includes transmitting, using the at least one processor, notification data to a device operable by the first counterparty. The notification data includes at least a portion of the output data. Further, the notification data causes an application program executed at the device to present the portion of the output data within a digital interface.

Further, in some examples, tangible, non-transitory computer-readable medium stores instructions that, when executed by at least one processor, cause the at least one processor to perform a method that includes obtaining first elements of decomposed message data. The first elements of decomposed message data are associated with exchanges of data involving a first counterparty, and characterize real-time payments requested by or from the first counterparty during a first temporal interval. Based on the first elements of decomposed message data, the method also includes determining a value of a plurality of parameters that characterize the first counterparty during the first temporal interval. Further, and based on the first elements of decomposed message data and on the parameter values, the method includes generating output data indicative of a likelihood of an occurrence of an event during at least one of the first temporal interval or a second temporal interval. The method also includes transmitting notification data to a device operable by the first counterparty. The notification data includes at least a portion of the output data. Further, the notification data causes an application program executed at the device to present the portion of the output data within a digital interface.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a block diagram of an exemplary computing environment, in accordance with some exemplary embodiments.

FIG. 2A is a block diagram illustrating a portion of an exemplary computing environment, in accordance with some exemplary embodiments.

FIG. 2B illustrates portions of an exemplary request for payment (RFP), in accordance with some exemplary embodiments.

FIGS. 3A, 3B, and 4A, 4B, 4C, and 4D are block diagrams illustrating portions of an exemplary computing environment, in accordance with some exemplary embodiments.

FIG. 5 is a flowchart of exemplary process for decomposing a request-for-payment (RFP) message formatted and structured in accordance with one or more standardized data-exchange protocols, in accordance with some exemplary embodiments.

FIG. 6 is a flowchart of an exemplary process 600 for generating real-time insights on customer transactional behavior, financial health, and financial well-being based on real-time-payment (RTP) messages formatted and structured in accordance with one or more standardized data-exchange protocols, in accordance with some exemplary embodiments.

FIG. 7 is a flowchart of an exemplary process 700 for managing customer risk based on real-time-payment (RTP) messages formatted and structured in accordance with one or more standardized data-exchange protocols, in accordance with some exemplary embodiments.

Like reference numbers and designations in the various drawings indicate like elements.

### DETAILED DESCRIPTION

Today, the mass adoption of smart phones and digital payments within the global marketplace drives an adoption of real-time payment (RTP) technologies by financial institutions, consumers, vendors and merchants, and other participants in the payment ecosystem. These RTP technologies often emphasize data, messaging, and global interoperability and in contrast to conventional payment rails, may embrace the near ubiquity of mobile technologies in daily life to provide, to the participants in the RTP ecosystem, real-time service and access to funds. To facilitate the strong emphasis on data, messaging, and global interoperability between financial institutions, many RTP technologies adopt, and exchange data formatted in accordance with, one or more standardized data-exchange protocols, such as the ISO 20022 standard for electronic data exchange between financial institutions.

For example, a customer of a financial institution may initiate a transaction to purchases one or more products or services from a merchant or retailer, either through in-person interaction at a physical location of the merchant or retailer, or through digital interactions with a computing system of the merchant (e.g., via a web page or other digital portal). In some instances, and to fund the initiated purchase transaction, the customer may provide the merchant with data characterizing a payment instrument, such as credit card account issued by the financial institution (e.g., via input provisioned to the web page or digital portal, or based on an interrogation of a physical payment card by point-of-sale terminal, etc.). The merchant computing system may perform operations that generate elements of messaging data that identify and characterize the merchant and the initiated purchase transaction, and that include portions of the data characterizing the payment instrument, and that submit the generated elements of messaging data to a transaction processing network or payment rail in accordance with a predetermined schedule, e.g., in batch form with other elements of messaging data at a predetermined time on a daily basis. In some instances, one or more computing systems of the transaction processing network or payment rail may perform operations that execute, clear, and settle the initiated purchase transaction involving the payment instrument within a predetermined temporal interval subsequent to the initiation of the purchase transaction, such as, but not limited to, forty-eight hours.

In other examples, the merchant and the financial institution of the customer may represent participants in the RTP ecosystem, and the merchant computing system (or a computing system associated with a financial institution of the merchant) may generate a message, e.g., a Request for Payment (RFP) message, that requests a real-time payment from the customer that funds the initiated purchase transaction, and may transmit that message to one or more computing systems of the financial institution of the customer, e.g., directly or through one or more intermediate systems associated with the RTP ecosystem, such as a clearinghouse system. The generated and transmitted RFP message may, for example, be formatted in accordance with the ISO 20022 data-exchange format, and may include message fields populated with information that includes, but is not limited to, information identifying the customer and the merchant, information characterizing the requested payment (e.g., a requested payment amount, a requested payment date, an identifier of an account selected by the customer to fund the requested, real-time payment, or an identifier of an account of the merchant capable of receiving the requested, real-time payment, etc.) and information characterizing the initiated purchase transaction (e.g., a transaction date or time, or an identifier of one or more of the products or services involved in the initiated purchase transaction, such as a corresponding UPC, etc.). Further, the ISO-20022-compliant RFP message may also include a link within a structured or unstructured message field to information, such as remittance data, associated with the requested, real-time payment (e.g., a long- or shortened Uniform Resource Location (URL) pointing to a formatted invoice or statement that includes any of the information described herein).

The elements of structured or unstructured data maintained within the message fields of exemplary, ISO-20022-compliant RFP messages described herein may extend beyond the often-limited content of the message data transmitted across many existing payment rails and transaction processing networks. Further, when intercepted and processed by a computing system of the financial institution of the customer (e.g., an FI computing system), these elements of structured or unstructured RFP message data may be processed by the FI computing system to determine, among other things, a customer intent associated with the initiated purchase transaction, to identify one or more targeted offers or incentives that are available to the customer and that are associated with, or consistent with, the determined customer intent, and to provision, to a device of the customer in real-time and contemporaneously with the receipt of the RFP message, elements of digital content of that not only prompt the customer to approve or reject the requested, real-time payment associated with the initiated purchase transaction, but that also prompt the customer to accept, or reject, each or a selected subset of the targeted offers of incentives.

Further, when intercepted and processed by a computing system of the financial institution of the customer (e.g., an FI computing system), these elements of structured or unstructured RFP message data may be processed by the FI computing system generate values of various transactional metrics that characterize the spending, savings, payment, and other transaction-related behaviors and habits, both in real-time and on a time-evolving basis, e.g., hourly or daily basis. The real-time transaction data and the transactional metric values may also enable the FI computing system to characterize, for a customer of the financial institution, a status of one or obligations held by that customer and a real-time, or time-evolving, cash flow associated with one or more financial accounts of that customer, which can be provisioned to the customer through a corresponding digital interface. For example, and based on the real-time transaction data, the FI computing system may determine a real-time score indicative of the financial health and well-being of the customer and, in some examples, determine one or more values of cashflow metrics. Further, the FI computing system may provision the score, and in some instances, the cashflow metric values, to an application program executed at the customer device for presentation within a digital interface, in real-time and contemporaneously with an initiation of a purchase transaction or a receipt of a RFP message data. Further, the processing of the elements of structured or unstructured RFP message data by the FI computing system may inform a risk profile of the customer of the financial institution, and may provide, to the financial institution, a broader amount of behavioral information that facilitates an assessment of a risk associated with the customer's behavior, and an identification of a potential default and corresponding remediating actions, in real-time and contemporaneously with the initiation of a purchase transaction (and prior to execution of that purchase transaction).

Certain of the exemplary processes described herein, which decompose the structured message fields of an ISO-20022-compliant RFP message to obtain elements of decomposed message data characterizing the customer, the merchant, the initiated purchase transaction, and the requested, real-time payment, which analyze the elements of decomposed message data to obtain elements of data characterizing not only a behavior of the customer but also a risk posed to the financial institution by the customer's behavior, which provision data characterizing the customer behavior to the customer device for presentation in a digital interface, or implement remediating actions in view of the assessed risk, in real-time and contemporaneously with the initiated purchase transaction. The FI computing system may implemented these exemplary processes in addition to, or as an alternate to, many processes that relay on the often-limited content of temporally delayed message data transmitted across many existing payment rails and transaction processing networks.

### A. Exemplary Computing Environments

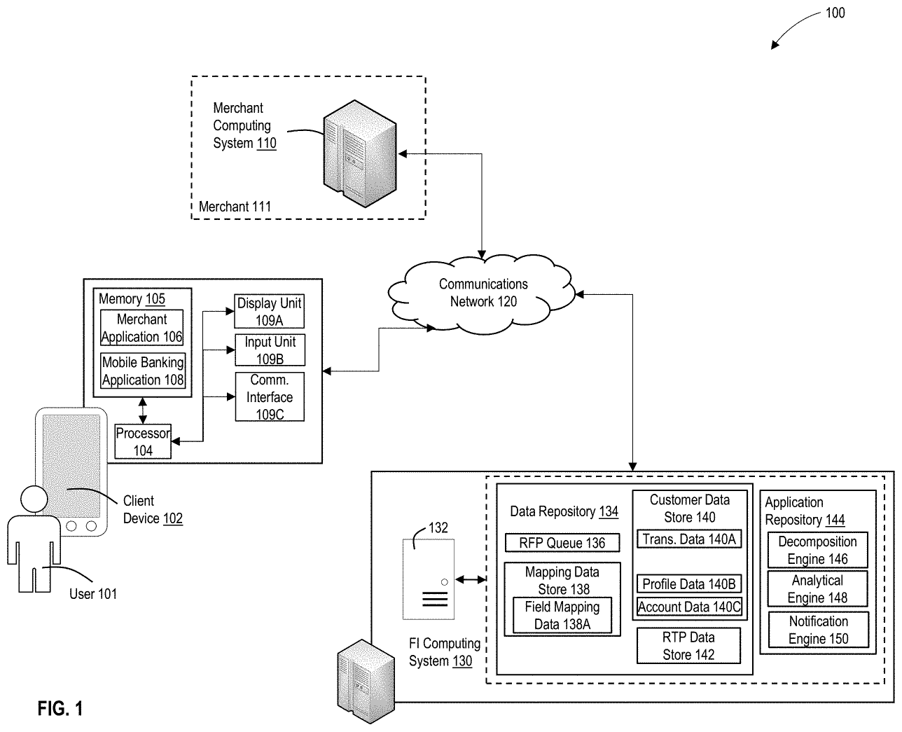

FIG. 1 is a diagram illustrating an exemplary computing environment 100 that includes, among other things, one or more computing devices, such as a client device 102, and one or more computing systems, such as a merchant computing system 110 and a financial institution (FI) system 130, each of which may be operatively connected to, and interconnected across, one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

Client device 102 may include a computing device having one or more tangible, non-transitory memories, such as memory 105, that store data and/or software instructions, and one or more processors, e.g., processor 104, configured to execute the software instructions. The one or more tangible, non-transitory memories may, in some aspects, store software applications, application modules, and other elements of code executable by the one or more processors, such as, but not limited to, an executable web browser (e.g., Google Chrome™, Apple Safari™, etc.), an executable application associated with merchant computing system 110 (e.g., merchant application 106), and additionally or alternatively, an executable application associated with FI computing system 130 (e.g., mobile banking application 108). In some instances, not illustrated in FIG. 1, memory 105 may also include one or more structured or unstructured data repositories or databases, and client device 102 may maintain one or more elements of device data and location data within the one or more structured or unstructured data repositories or databases. For example, the elements of device data may uniquely identify client device 102 within computing environment 100, and may include, but are not limited to, an Internet Protocol (IP) address assigned to client device 102 or a media access control (MAC) layer assigned to client device 102.

Client device 102 may also include a display unit 109A configured to present interface elements to a corresponding user, such as a user 101, and an input unit 109B configured to receive input from user 101, e.g., in response to the interface elements presented through display unit 109A. By way of example, display unit 109A may include, but is not limited to, an LCD display unit or other appropriate type of display unit, and input unit 109B may include, but is not limited to, a keypad, keyboard, touchscreen, voice activated control technologies, or appropriate type of input unit. Further, in additional aspects (not illustrated in FIG. 1), the functionalities of display unit 109A and input unit 109B may be combined into a single device, e.g., a pressure-sensitive touchscreen display unit that presents interface elements and receives input from user 101. Client device 102 may also include a communications interface 109C, such as a wireless transceiver device, coupled to processor 104 and configured by processor 104 to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Examples of client device 102 may include, but are not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface device or unit, such as display unit 109A. In some instances, client device 102 may also establish communications with one or more additional computing systems or devices operating within environment 100 across a wired or wireless communications channel, e.g., via the communications interface 109C using any appropriate communications protocol. Further, user 101 may operate client device 102 and may do so to cause client device 102 to perform one or more exemplary processes described herein.

Merchant computing system 110 and FI computing system 130 may each represent a computing system that includes one or more servers and one or more tangible, non-transitory memory devices storing executable code, application engines, or application modules. Each of the one or more servers may include one or more processors, which may be configured to execute portions of the stored code, application engines, or application modules to perform operations consistent with the disclosed exemplary embodiments. For example, as illustrated in FIG. 1, the one or more servers of FI computing system 130 may include server 132 having one or more processors configured to execute portions of the stored code, application engines, or application modules maintained within the one or more corresponding, tangible, non-transitory memories. In some instances, merchant computing system 110 or FI computing system 130 may correspond to a discrete computing system, although in other instances, merchant computing system 110 or FI computing system 130 may correspond to a distributed computing system having multiple, computing components distributed across an appropriate computing network, such as communications network 120 of FIG. 1, or those established and maintained by one or more cloud-based providers, such as Microsoft Azure™, Amazon Web Services™, or another third-party, cloud-services provider. Further, each of merchant computing system 110 and FI computing system 130 may also include one or more communications units, devices, or interfaces, such as one or more wireless transceivers, coupled to the one or more processors for accommodating wired or wireless internet communication across network 120 with other computing systems and devices operating within environment 100 (not illustrated in FIG. 1).

By way of example, merchant computing system 110 may be associated with, or operated by, a merchant 111 that offers products or services for sale to one or more customers, such as, but not limited to, user 101 that operates client device 102. In some instances, merchant computing system 110 may exchange data programmatically with one or more application programs executed at client device 102, such as merchant application 106, and based on the programmatically exchanged data, client device 102 may perform any of the exemplary processes described herein to initiate a transaction to purchase one or more of the products or services offered for sale by merchant 111. Further, and as described herein, FI computing system 130 may be associated with, or operated by, a financial institution that offers financial products or services to one or more customers, such as, but not limited to, user 101. The financial products or services may, for example, include a payment instrument issued to user 101 by the financial institution and available to fund the initiated purchase transaction, and examples of the payment instrument may include, but are not limited to, a credit card account issued by the financial institution or a checking, savings, or other deposit account issued by and maintained at the financial institution.

In some instances, FI computing system 130 may perform any of the exemplary processes described herein to obtain, receive, or intercept a request-for-payment (RFP) message associated with an initiated purchase transaction between a first counterparty (e.g., user 101 of FIG. 1) and a second counterparty (e.g., merchant 111 of FIG. 1). As described herein, the received RFP message may be formatted and structured in accordance with one or more standardized data-exchange protocols, such as the ISO 20022 standard for electronic data exchange between financial institutions. Further, and based on elements of mapping data that characterize a structure, composition, or format of one or more data fields of the ISO-20002-compliant RFP message, FI computing system 130 may perform any of the exemplary processes described herein to decompose the received RFP message and obtain data characterizing user 101, merchant 111, and additionally, or alternatively, the initiated purchase transaction. For example, the obtained data may include one or more of: (i) customer data identifying user 101, such as a unique customer identifier; (ii) payment data characterizing the real-time payment transaction, such as a transaction type (e.g., credit, debit, etc.), transaction amount, a requested transaction date or time, an identifier of a product or service involved in the transaction, and identifiers of a customer account (e.g., from which the transaction amount will be debited) and/or a merchant account (e.g., to which the transaction amount will be credited); and (iii) counterparty data identifying the second counterparty, such as a counterparty name (e.g., a merchant name, a financial institution, a vendor, etc.) or identifier (e.g., a standard industrial classification (SIC) code).

Further, in some instances, FI computing system 130 may also perform any of the exemplary processes described herein to determine one or more customer-specific values of transactional metrics based on the data obtained from the message fields of the received RFP message, and from elements of decomposed field data obtained from the message fields of previously received RFP messages, over one or more temporal intervals. By way of example, FI computing system 130 may determine customer-specific values of one or more transactional metrics that characterize a spending, savings, or transactional behavior of user 101 over specified temporal intervals, and the customer-specific values of the transactional metrics may include, but are not limited to, an average payroll deposit amount received user 101's financial accounts on a daily, weekly, yearly, or monthly basis, and additionally, or alternatively, an average amount saved by the customer (e.g., as a difference between the payroll deposit amount and the payment amounts over a particular temporal interval) on a daily, weekly, monthly, or yearly basis. In other examples, the one or more transactional metrics may include, but are not limited to, an average value of all payments requested from user 101 on a daily, weekly, monthly, or yearly basis, or value of payment requested by particular merchants during these during these intervals, (e.g., an amount spent on fuel, an amount spent at convenience stores, etc.).

Further, and based on the one or more customer-specific values of the transactional metrics, FI computing system 130 may perform any of the exemplary processes described herein to determine a numerical score characterizing a current financial condition for one or more of the customers such as user 101, in real-time and contemporaneously with a receipt of the RFP message or a request from a device operable by user 101, such as client device 102. Further, FI computing system 130 may perform any of the exemplary processes described herein to generate digital content for provisioning the numerical score, and in some instances, the one or more transactional metric values, to client device 102 for presentation within a digital interface established by an executed application program such as mobile banking application 108. By provisioning the real-time score in real-time and contemporaneously with the receipt of the RFP message, the financial institution may enable user 101 (e.g., via a digital interface of executed mobile banking application 108) to access a real-time “snapshot” of their financial health and well-being and to determine an impact of certain spending, payment, and savings decisions on not only user 101's financial health and well-being, but, in some instances, in relation to certain customer-specific budget, savings, or financial goals.

In some instances, FI computing system 130 may compute additional, customer-specific values of these transactional metrics across one or more additional customers of the financial institution that are demographically similar to the customer and, as such, establish a peer group that includes the customer (e.g., group-specific values of the transactional metrics). FI computing system 130 may also perform any of the exemplary processes described herein to compare the customer-specific values of these transactional metrics, which may provide insights regarding the financial health or well-being of user 101, with corresponding group-specific values of transactional metrics for the peer group that includes user 101, and in some instances, FI computing system 130 perform operations that generate the numerical score for user 101 based on an outcome of the comparison. For example, a magnitude of the numerical score may indicate a relative financial health or well-being of user 101 when compared to the peer group that includes user 101 (e.g., indicating the financial health or well-being of user 101 is higher, or lower, than that of the peer group).

Further, and based on one or more of the customer-specific values of the transactional metrics associated with user 101, FI computing system 130 may also perform any of the exemplary processes described herein to generate values of one or more risk metrics indicative of a risk posed to the financial institution by a use, or misuse, of financial products by user 101. For example, and based on the one or more customer-specific values of the transactional metric, FI computing system 130 may perform any of the exemplary processes described herein to generate a value of one or more risk metrics that characterize a risk that user 101 will default on a payment associated with a secured or unsecured credit product issued by the financial institution (e.g., a payment associated with a home mortgage or auto loan), or alternatively, by merchant 111. In some instances, FI computing system 130 may also perform operations, described herein, that modify a risk profile of user 101 in accordance with the level of risk characterized by the magnitudes of the values of the risk metrics.

To facilitate a performance of one or more of these exemplary processes, FI computing system 130 may maintain, within the one or more tangible, non-transitory memories, a data repository 134 that includes, but is not limited to, a request-for-payment (RFP) message queue 136, a mapping data store 138, a customer data store 140, and a RTP data store 142. RFP queue 136 may include one or more discrete RFP messages received by FI computing system 130 using any of the exemplary processes described herein. In some instances, the RFP messages maintained within RFP queue 136 may be prioritized in accordance with a time or date of receipt by FI computing system 130 or with requested payment data associated with each of the RFP messages, and each of the prioritized RFP messages may be associated with a corresponding temporal pendency. Further, FI computing system 130 may perform any of the exemplary processes described herein to provision elements of notification data associated with each of the RFP messages to a computing system or device associated with a corresponding customer (e.g., client device 102 associated with user 101), and FI computing system 130 may perform operations that maintain each of the RFP messages within RFP queue 136 until a receipt, at FI computing system 130, of confirmation data from corresponding ones of the computing systems or devices indicating an approval, or a rejection, of the corresponding requested payment, or until an expiration of the corresponding pendency period.

Mapping data store 138 may include structured or unstructured data records that maintain one or more elements of field mapping data 138A. For example, and as described herein, FI computing system 130 may receive, obtain, or intercept one or more RFP messages, each of which may be formatted and structured in accordance with a corresponding, standardized data-exchange protocol, such as the ISO 20022 standard for electronic data exchange between financial institutions. In some instances, the one or more elements of field mapping data 138A may characterize a structure, composition, or format of the message data populating one or more data fields of the ISO-20002-compliant RFP message, or a corresponding RFP message compliant with an additional, or alternate, standardized data-exchange protocol.

In some instances, customer data store 140 may include structured or unstructured data records that maintain information identifying and characterizing one or more customers of the financial institution, and further, interactions between these customers and not only the financial institution, but also other unrelated third parties, such as the merchants or retailers described herein. For example, as illustrated in FIG. 1, customer data store 140 may include one or more elements of transaction data 140A, which identify and characterize prior deposit, purchase, or payment transactions involving corresponding customers of the financial institution (such as, but not limited to, user 101), one or more elements of customer profile data 140B, which identify and characterize, for each of the customers, one or more of a customer identifier (e.g., a customer name or an alphanumeric login credential, etc.), demographic parameters, financial or budgetary goals (such as an expected cost of a future vacation or a desired balance of a savings account, etc.), and a risk profile (e.g., a risk of defaulting on a payment, such as a loan payment). The risk profile may include, for example, a real-time risk score characterizing a risk of associated with a use, or misuse, of financial products provisioned to corresponding customers by the financial institution (e.g., a risk of default on a payment, such as a loan payment) and, in some instances, customer-specific and group-specific values of transactional metrics that characterize corresponding ones of the customers, such as user 101, and corresponding peer group.

Customer data store may also include one or more elements of account data 140C, which may identify and characterize a financial instrument, such a credit card account, issued to customers by the financial institution or merchants (e.g., merchant 111), and a status of balance of one or more financial accounts held by the customers. Account data 140C may also include customer-specific values of transactional metrics that characterize an impact of a transition from scheduled payments at a first temporal granularity to scheduled payments at a second temporal granularity, as described herein. For example, for user 101, the elements of account data 140C may characterize a financial impact of a transition from scheduled monthly (or bi-monthly) mortgage payments, credit card payments or scheduled payroll deposit, to more temporally granular payments or deposits, such as, but not limited to, a daily mortgage payment (e.g., which facilitates an earlier payment of interest and build equity) or a daily payroll deposit.

RTP data store 142 may include one or more elements of decomposed field data generated through a decomposition of corresponding ones of the received RFP messages, e.g., based on the elements of field mapping data 138A and through an implementation of any of the exemplary processes described herein. In some instances, the elements of decomposed field data maintained within RTP data store 142 may establish a time-evolving record of real-time payment transactions initiated by, or involving, the individual and small-business customers during a current temporal interval and across one or more prior temporal intervals, and across various merchant classifications or geographic region.

Further, and to facilitate the performance of any of the exemplary processes described herein, FI computing system 130 may also maintain, within the one or more tangible, non-transitory memories, an application repository 144 that maintains, but is not limited to, a decomposition engine 146, an analytical engine 148, and a notification engine 150, each of which may be executed by the one or more processors of server 132.

For example, and upon execution by the one or more processors of FI computing system 130, executed decomposition engine 146 may perform any of the exemplary processes described herein to obtain field mapping data 138A from mapping data store 138, to apply field mapping data 138A to a received, obtained, or intercepted RFP message, and based on the application of field mapping data 130A to the RFP message, to decompose the RFP message and obtain elements of message data that not only identify and characterize each counterparty involved in an initiated purchase transaction (e.g., a customer of the financial institution, such as user 101, and merchant 111, described herein), but that also characterize the initiated purchase transaction.

Further, and upon execution by the one or more processors of FI computing system 130, executed analytical engine 148 may perform any of the exemplary processes described herein to process the elements of message data obtained from the message fields of the RFP message to determine one or more transactional metric values that characterize, for example, a spending, savings, payment, or any other transaction-related behaviors and habits of the customer of the financial institution, such as user 101. Executed analytical engine 148 may further generate, based on the one or more transactional metric values, a real-time indicator (e.g., a real-time score) of a current financial condition of that customer. Additionally or alternatively, and upon execution by the one or more processors of FI computing system 130, executed analytical engine 148 may perform any of the exemplary processes described herein to process the elements of message data obtained from the message fields of the RFP message to determine additional values of transactional metrics that characterize the customer and the customer's peer group, and in some instances values of transactional metrics that characterize an impact of a transition from scheduled payments at a first temporal granularity to scheduled payments at a second temporal granularity, as described herein.

Further, and upon execution by the one or more processors of FI computing system 130, executed analytical engine 148 may, additionally or alternatively, perform any of the exemplary processes described herein to process the elements of message data obtained from the message fields of the RFP message (either alone or in conjunction with other elements of transaction data 140A or account data 140C associated with the customer) to generate cashflow metric values that characterize, either in real time or over various temporal intervals as described herein, an expected inflow of funds into the customer's financial accounts, an expected outflow of funds from the counterparty's financial accounts, and, based on the expected inflow and outflow of funds, an amount of excess funds available within the counterparty's financial accounts (e.g., maintained at the financial institution).

Upon execution by the one or more processors of FI computing system 130, notification engine 150 may perform any of the exemplary processes described herein to generate elements of notification data that include one or more of the transactional metric values, the real-time indicator, or the cashflow metric values described herein. When provisioned to client device 102 by FI computing system 130, causes one or more application programs executed by client device 102 (e.g., mobile banking application 108) to process the elements of notification data and present, within a corresponding digital interface, interface elements that identify and characterize a current financial health or condition of the customer, either in real-time and contemporaneously with the initiation of the purchase transaction and the receipt of the RFP message, or in response to a request of a corresponding request generated by executed mobile banking application 108. The notification data may, additionally or alternatively, include a payment notification that, when provisioned to client device 102 by FI computing system 130, causes executed mobile banking application 108 to present, within the corresponding digital interface, interface elements that prompt user 101 to provide an approval of the real-time payment requested by merchant 111 via the RFP message, e.g., contemporaneously with the initiation of the purchase transaction.

B. Computer-Implemented Processes for Determining and Provisioning Targeted Behavioral Data in Real-Time based on Decomposed Structured Messaging Data

In some instances, a customer of the financial institution, such as user 101, may elect to initiate a purchase of a product or service from a particular merchant, such as merchant 111, and may provide input to client device 102 (e.g., via input unit 109B) that triggers an execution of one or more locally maintained application programs associated with merchant 111, such as merchant application 106. By way of example, merchant 111 may correspond to a local running shop (e.g., “Foggy Bottom Running”), and upon execution by the one or more processors of client device 102, executed merchant application 106 may perform operations that present, via display unit 109A, a digital interface 200 that enables user 101 to select for purchase one or more products offered for sale by merchant 111 (e.g., running shoes, socks, cold-weather running gear, etc.), and to submit payment for the products to merchant 111.

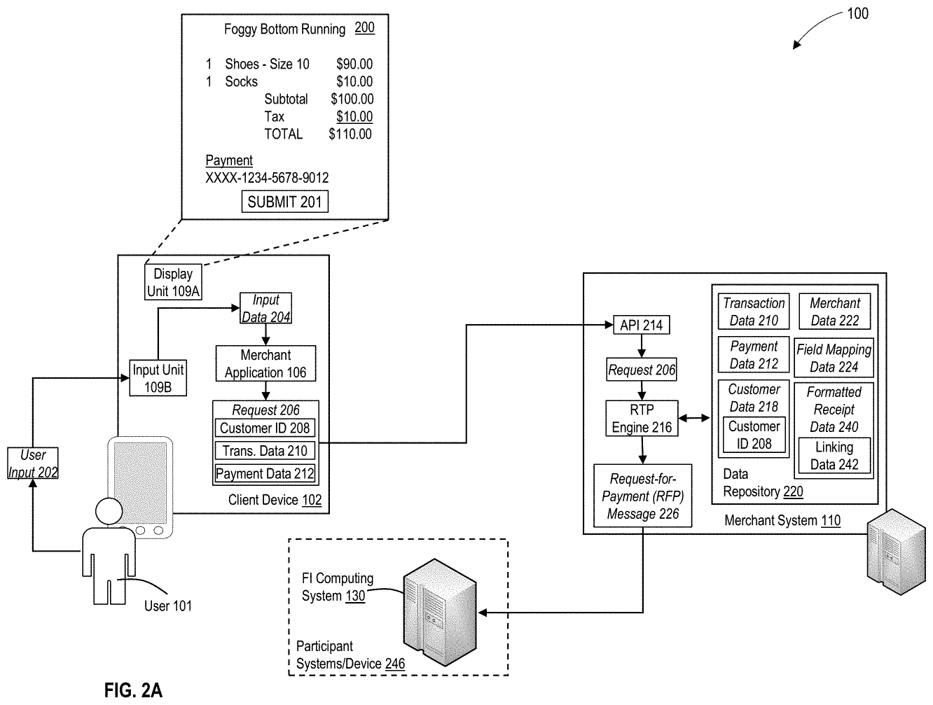

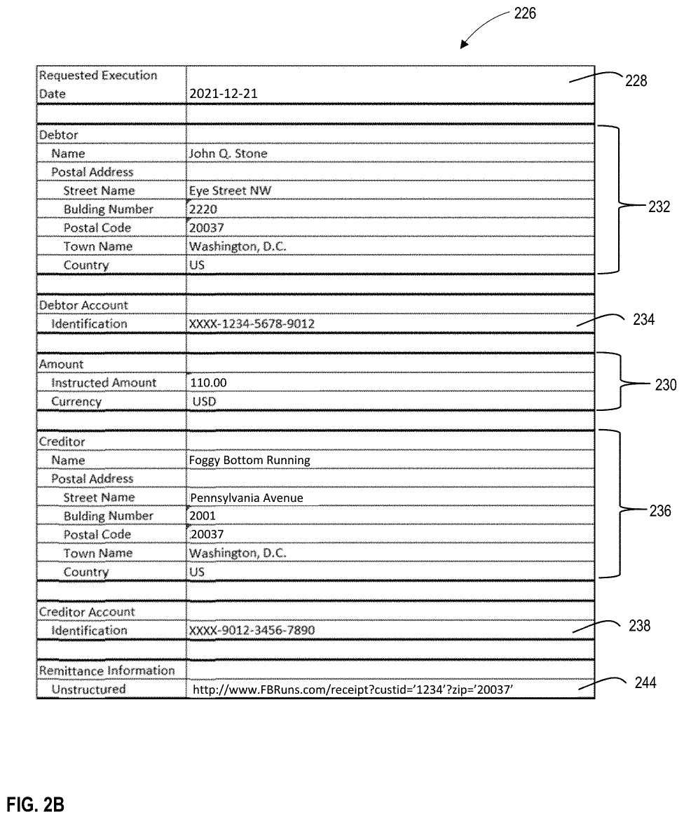

Based on portions of a digital interface, user 101 may provide input to input unit 109B of client device 102 that specifies a selection of a pair of running shoes in size ten and pair of running socks for purchase and that specifies a particular payment instrument available to fund the purchased running shoes and socks (e.g., a credit card account or deposit issued to user 101 by the financial institution, etc.). For example, as illustrated in FIG. 2A, digital interface 200 may include interface elements that specify the selection, by user 101, of the running shoes at $90.00 and the running socks at $10.00 for purchase, and that specify a pre-tax subtotal of $100.00 for the purchased running shoes and socks and an imposed sales tax of $10.00, and further, a total purchase price of $100.00. Further, the interface elements may also specify payment data that identifies the particular payment instrument available to fund the purchase transaction, such as an account number (e.g., “XXXX-1234-5678-9012”), an expiration date, and/or a card verification code. As illustrated in FIG. 2A, all or a selected portion of the payment data presented within digital interface 200 may be tokenized or otherwise obscured to, among other things, maintain a confidentiality of the presented elements of payment data.

Further, as illustrated in FIG. 2A, digital interface 200 may also include a selectable interface element, such as “SUBMIT” icon 201, that when selected by user 101, confirms an intention of user 101 to initiate the $110.00 purchase of the running shoes and socks involving the particular payment instrument, and requests a submission of corresponding elements of transaction and payment information to a computing system associated with merchant 111, e.g., merchant computing system 110. For example, input unit 109B of client device 102 may receive additional input 202 indicative of a selection, by user 101, of SUBMIT icon 201, and may route, to executed merchant application 106, input data 204 that includes, but is not limited to, information specifying the purchased products, the subtotal, imposed sales tax, and total purchase price, and the particular payment instrument that funds the initiated purchase transaction.

In some instances, executed merchant application 106 package all, or a selected portion, of input data 204 into corresponding portions of a purchase request 206, and may perform operations that cause client device 102 to transmit purchase request 206 across network 120 to a computing system associated with merchant 111, such as merchant computing system 110. Further, although not illustrated in FIG. 2A, executed merchant application 106 may also perform operations that encrypt all, or a portion, of purchase request 206 using an appropriate encryption key (e.g., a public cryptographic key of merchant computing system 110, etc.) prior to transmission across network 120.

In some instances, purchase request 206 may include a customer identifier 208 associated with user 101 (e.g., an alphanumeric login credential that uniquely identifies user 101 at merchant computing system 110), elements of transaction data 210 that specify values of one or more parameters characterizing the initiated purchase transaction, and elements of payment data 212 that specify the particular payment instrument selected to fund the purchase transaction. For example, the elements of transaction data 210 may include an identifier of each of the purchased products (e.g., a universal product code (UPC) associated with the running shoes and socks, etc.), the subtotal for the purchase transaction (e.g., $100.00), the imposed sales tax (e.g., $10.00), the total purchase price (e.g., $100.00), and a time or date of the initiated purchase transaction (e.g., 9:30 a.m. on Dec. 22, 2021). Additionally, in some examples, the elements of payment data 212 may include, among other things, all or a selected portion of the account number (e.g., in tokenized form, etc.), the corresponding expiration data, and/or the corresponding card verification code.

A programmatic interface established and maintained by merchant computing system 110, such as application programming interface (API) 214, may receive purchase request 206 from client device 102, and may route purchase request 206 to a real-time payment (RTP) engine 216 executed by the one or more processors of merchant computing system 110. In some instances, as described herein, all, or a selected portion, of purchase request 206 may be encrypted, and executed RTP engine 216 may perform operations that decrypt the encrypted portions of purchase request 206 using a corresponding, and appropriate, decryption key, such as a private cryptographic key associated with merchant computing system 110. Executed RTP engine 216 may also perform operations that, based on portions of purchase request 206, verify that user 101 represents a registered customer of merchant 111. For example, executed RTP engine 216 may parse purchase request 206 and obtain customer identifier 208, which uniquely identifies user 101, and identify one or more elements of customer data associated with customer identifier 208 within a corresponding merchant data repository 220. The identified elements of customer data 218 may include, among other things, a full name of user 101 and a postal address of user 101, and based on the identification of the elements of customer data 218 and their association with customer identifier 208, executed RTP engine 216 may verify that user 101 represents a registered customer of merchant 111.

Executed RTP engine 216 may also extract, from merchant data repository 220, one or more elements of merchant data 222 and one or more elements of field mapping data 224. In some instances, the one or more elements of merchant data 222 may include, but are not limited to, an identifier of merchant 111 (e.g., a merchant name, such as “Foggy Bottom Running”), a postal address associated with merchant 111 (e.g., an actual postal address, a generic postal address, etc.), and information that identifies a financial services account associated with merchant 111 and capable of receiving proceeds from one or more of the purchased transactions described herein (e.g., an account number, a routing number, etc.). Further, the one or more elements of field mapping data 224 may characterize a structure, composition, or format of one or more data fields of an ISO-20002-compliant RFP message, such as those described herein, and additionally, or alternatively, an RFP message compliant with another standardized data-exchange protocol.

Executed RTP engine 216 may parse purchase request 206 and obtain the one or more elements of transaction data 210 that specify the parameter values characterizing the initiated purchase transaction, and elements of payment data 212 that specify the particular payment instrument selected to fund the initiated purchase transaction. In some instances, based on portions of the elements of transaction data 210, payment data 212, customer data 218, and merchant data 222, executed RTP engine 216 may perform any of the exemplary processes described herein to generate a request-for-payment (RFP) message 226 that is structured and formatted in accordance with the one or more elements of field mapping data 224 and that requests a payment from user 101 for the initiated purchase transaction (e.g., the $110.00 purchase of the running shoes and socks at 9:30 a.m. on Dec. 21, 2021) not at a close of a corresponding business or calendar day, but instead in real-time and contemporaneously with the initiation of the purchase transaction by client device 102. As described herein, RFP message 226 may be structured in accordance with the ISO 20022 standard for electronic data exchange between financial institutions, and in some examples, RFP message 226 may correspond to a pain.013 message as specified within the ISO 20022 standard. Further, and as described herein, the one or more elements of field mapping data 224 may characterize a structure, composition, or format of one or more data fields of ISO-20002-compliant RFP message 226 (e.g., the one or more data fields within the pain.013 message).

By way of example, ISO-20022-compliant RFP message 226 may include among other things: (i) message fields populated with data specifying a full name and postal address of user 101; (ii) message fields populated with data identifying a payment instrument selected by user 101 to fund the initiated purchase transaction; (iii) message fields populated with data specifying a name and postal address of merchant 111; (iv) message fields populated with data identifying a financial services account held by merchant 111 and available to receive processed from the requested payment; and (v) message fields populated with one or more parameter values that characterize the initiated purchase transaction, a requested payment method, and/or a requested payment date. Further, ISO-20022-compliant RFP message 226 may also include one or more structured or unstructured message fields that specify additional information associated with the initiated purchase transaction.

Examples of the additional information include, but are not limited to, information identifying a product or service involved in the initiated purchase transaction, or a link to remittance data associated with the initiated transaction (e.g., a link to a PDF or HTML invoice identifying the merchant/vendor, the geographic location of the merchant/vendor, or the purchased product or service). In some instances, as described herein, the link may include a long-form uniform resource locator (URL) into which certain elements of positional or customer data may be embedded, such as, but not limited to, the actual postal code of merchant 111 or the unique identifier of user 101. In other instances, the link may include a shortened URL, such as a tiny URL, actionable by FI computing system 130 using any of the exemplary processes described herein.

In some instances, executed RTP engine 216 may parse the elements of transaction data 210, payment data 212, customer data 218, and merchant data 222, and may perform operations that populate the message fields of RFP message 226 with corresponding elements of elements of transaction data 210, payment data 212, customer data 218, and merchant data 222 in accordance with field mapping data 224. For example, executed RTP engine 216 may parse transaction data 210 and obtain data that specifies a requested payment date (e.g., Dec. 21, 2021), a requested payment amount (e.g., the $100.00 total purchase price), and a currency associated with that requested payment amount (e.g., U.S. dollars). Executed RTP engine 216 may also format the requested payment data, the requested payment amount, and the requested payment currency in accordance with portions of field mapping data 224. As illustrated in FIG. 2B, executed RTP engine 216 may perform operations that populate message field 228 of RFP message 226 with the formatted payment date (e.g., “2021-12-21”) and message fields 230 of RFP message 226 with respective ones of the formatted payment amount (e.g., “100.00”) and formatted payment current (e.g., “USD”).

Further, executed RTP engine 216 may parse the elements of customer data 218 to obtain a name of user 101 (e.g., “John Q. Stone”) and a postal address associated with user 101 (e.g., “2223 Eye Street NW, Washington, D.C., 20037, US”), and may parse the elements of payment data 212 to obtain information that identifies (e.g., an “identification” of) the payment instrument selected by user 101 to fund the purchase transaction (e.g., the account number “XXXX-1234-5678-9012”). In some instances, executed RTP engine 216 may format the obtained customer name, the obtained customer address, and the obtained identification of the payment instrument in accordance with portions of field mapping data 224, and as illustrated in FIG. 2B, executed RTP engine 216 may perform operations that populate message fields 232 of RFP message 226 with respective portions of the formatted customer name and customer address, and that populate message field 234 with the formatted identification of the selected payment instrument.

Executed RTP engine 216 may also parse the elements of merchant data 222 to obtain a name of merchant 111 (e.g., “Foggy Bottom Running”), a postal address associated with merchant 111 (e.g., “2001 Pennsylvania Avenue NW, Washington, D.C., 20037, US”), and that identifies (e.g., an “identification” of) a financial services account associated with merchant 111 and capable of receiving proceeds from one or more of the purchased transactions (e.g., the account number “XXXX-9012-3456-7890”). In some instances, executed RTP engine 216 may format the obtained merchant name, the obtained merchant address, and the obtained identification of the merchant account in accordance with portions of field mapping data 224, and as illustrated in FIG. 2B, executed RTP engine 216 may perform operations that populate message fields 236 of RFP message 226 with respective portions of the formatted merchant name and merchant address, and that populate message field 238 with the formatted identification of the merchant account.

Further, and as described herein, RFP message 226 may also include one or more message fields that specify remittance information associated with the initiated purchase transaction, such as, but not limited to, a link to a PDF or HTML invoice identifying merchant 111, a postal address associated with merchant 111, or the purchased products or services. For example, and upon receipt of purchase request 206, merchant computing system 110 (e.g., via executed RTP engine 216 or one or more other executed application programs, engines, or modules) may generate one or more elements of formatted receipt data 240 that identify merchant 111 (e.g., “Foggy Bottom Running”), a postal address associated with merchant 111 (e.g., “2001 Pennsylvania Avenue NW, Washington, D.C., 20037, US”), and one or more elements of transaction data 210 (e.g., names and/or UPCs of the purchased large coffee and blueberry muffin, the $100.00 subtotal of the purchase transaction, the $10.00 sales tax, the $110.00 total purchase amount, etc.) or payment data 212 (e.g., a tokened portion of the account number of the selected payment instrument, etc.). In some instances, merchant computing system 110 may perform operations that store the elements of formatted receipt data 240 within a portion of data repository 220, along with corresponding elements of linking data 242 that include, among other things, a long-form or shortened URL associated with the stored elements of formatted receipt data 240 (e.g., that point to the storage location of formatted receipt data 240 within data repository 220).

In some instances, executed RTP engine 216 may perform operations that obtain linking data 242 from data repository 220, and that process and package all, or a selected portion, of linking data 242 within a corresponding unstructured message field of RFP message 226. For example, linking data 242 may include a long-form URL that points to formatted receipt data 240 maintained within data repository 220 and includes the actual postal code of merchant 111 (e.g., “20037”) and the customer identifier of user 101 (e.g., http://www.FBRuns.com/receipt?custid=‘1234’?zip=‘20037’), and as illustrated in FIG. 2B, executed RTP engine 216 may parse linking data 242, obtain the long-form URL, and package the long-form URL into an unstructured message field 244 of RFP message 226. The disclosed embodiments are, however, not limited to RFP messages populated with these exemplary elements of customer, merchant, payment, transaction, and additional remittance data, and in other examples, RFP message 226 may include any additional, or alternate, message fields specified within field mapping data 224 and consistent with the ISO 20022 standard for electronic data exchange, and executed RTP engine 216 may populate these message fields with any additional, or alternate, structured and formatted elements of customer, merchant, payment, transaction, or additional remittance data appropriate to RFP message 226 and field mapping data 224.

As illustrated in FIG. 2A, executed RTP engine 216 may perform operations that cause merchant computing system 110 to broadcast now-populated RFP message 226 across network 120 to one or more computing systems or devices 246 within environment 100 that are associated with participants in the RTP ecosystem, such as, but not limited to, FI computing system 130 or client device 102. In some instances, and prior to broadcasting now-populated RFP message 226 across network 120, executed RTP engine 216 may perform operations that encrypt RFP message 226 using a corresponding encryption key, and examples of the corresponding encryption key include, but are not limited to, a public cryptographic key associated with FI computing system 130.

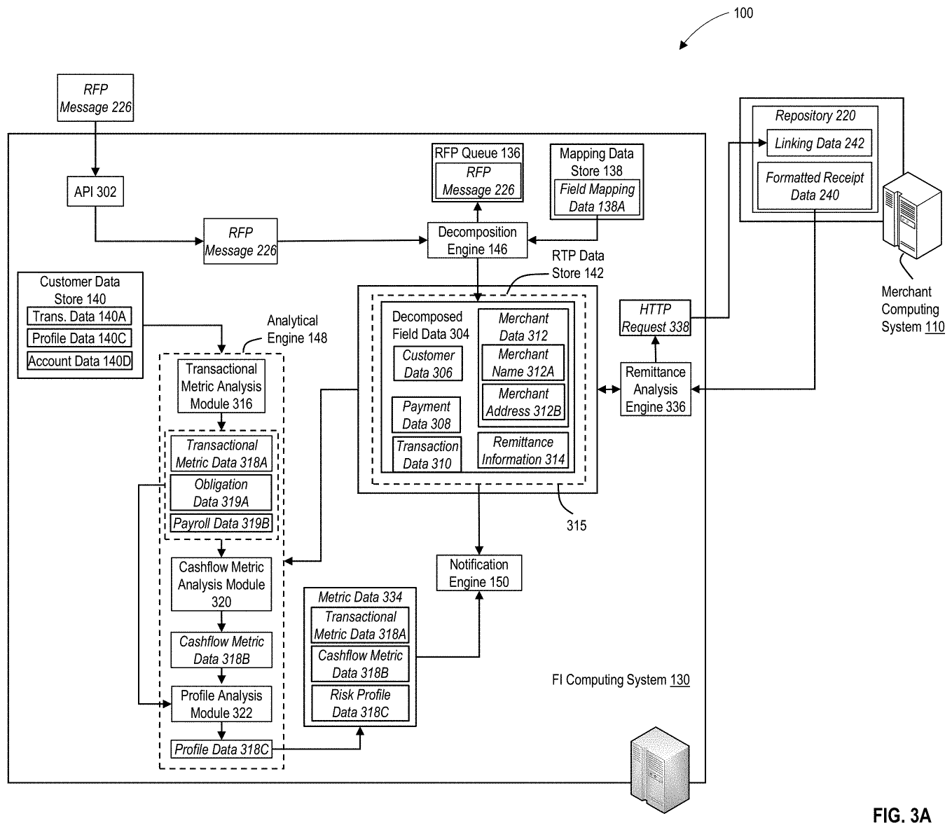

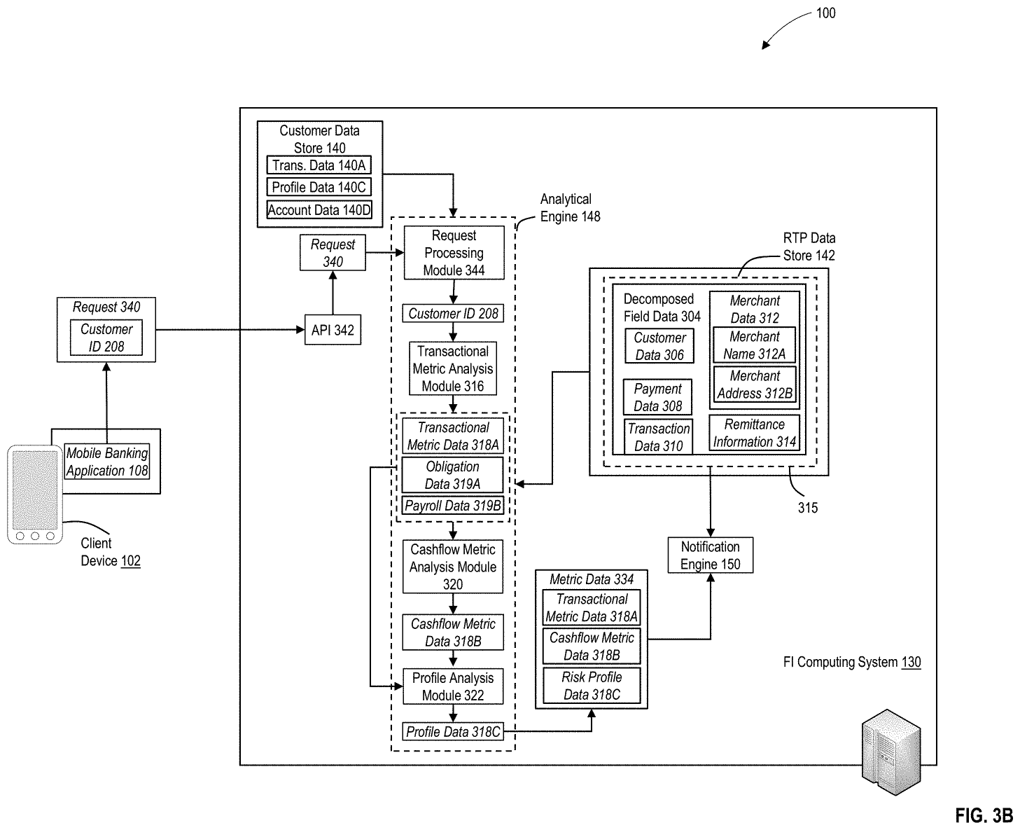

Referring to FIG. 3A, a programmatic interface established and maintained by FI computing system 130, such as application programming interface (API) 302, may receive RFP message 226, and may route RFP message 226 to decomposition engine 146, which may be executed by the one or more processors of FI computing system 130. In some examples, FI computing system 130 may receive RFP message 226 directly across network 120 via a channel of communications established programmatically between API 302 and executed RTP engine 216 of merchant computing system 110. In other examples, FI computing system 130 may receive RFP message 226 across network 120 from one or more of computing systems or devices 246 associated with the participants in the RTP ecosystem. Further, and as described herein, one or more portions of RFP message 226 may be encrypted (e.g., using a public cryptographic key associated with FI computing system 130), and executed decomposition engine 146 may perform operations that access a corresponding decryption key maintained within the one or more tangible, non-transitory memories of FI computing system 130 (e.g., a private cryptographic key associated with FI computing system 130), and that decrypt the encrypted portions of RFP message 226 using the corresponding decryption key.

In some instances, executed decomposition engine 146 may store RFP message 226 (in decrypted form) within a corresponding portion of data repository 134, e.g., within RFP queue 136. Executed decomposition engine 146 may also perform operations that access mapping data store 138 (e.g., as maintained within data repository 134), and obtain one or more elements of field mapping data 138A that characterize a structure, composition, or format of one or more data fields of RFP message 226. For example, and as described herein, RFP message 226 may include message fields consistent with the ISO 20022 standard for electronic data exchange between financial institutions, and each of the message fields may be populated with data structured and formatted in accordance with the ISO 20022 standard.

As described herein, RFP message 226 may be associated with a real-time payment of a monetary amount, such as $100.00, requested from user 101 by merchant 111 for purchased goods, such as the running shoes and socks purchased on Jun. 15, 2021. By way of example, RFP message 226 may include, but is not limited to, a message field populated with data specifying the requested payment date of December 21^{st} (e.g., message field 228 of FIG. 2B) and message fields populated within data specifying the requested payment amount of US $100.00 (e.g., message fields 230 of FIG. 2B). RFP message 226 may also include, but is not limited to, message fields populated with data that identify and characterize user 101 (e.g., message fields 232 of FIG. 2B) and merchant 111 (e.g., message fields 236 of FIG. 2B), along with additional message fields populated with data that identify the payment instrument selected by user 101 to fund the purchase transaction (e.g., message field 234 of FIG. 2B) and the financial services account associated with merchant 111 and capable of receiving proceeds from the purchase transaction (e.g., message field 238 of FIG. 2B). Further, and as described herein, RFP message 226 may include one or more additional data fields populated with structured or unstructured remittance data, such as, but not limited to, a long-form URL that points to formatted receipt data 240 maintained within data repository 220 (e.g., message field 244 of FIG. 2B, which may include http://FBRuns.com/receipt?custid=‘1234’?zip=‘20037’). The disclosed embodiments are, however, not limited to structured or unstructured remittance data that includes a long-form URL, and in other instances, the structured or unstructured remittance data may include one or more identifiers (e.g., UPCs, etc.) of the purchased products or a shortened URL that points to formatted receipt data 240.

Based on the obtained elements of field mapping data 138A, executed decomposition engine 146 may perform operations that parse RFP message 226 and obtain elements of decomposed field data 304 that identify and characterize user 101, merchant 111, and the requested payment for the purchase transaction initiated on Jun. 15, 2021. In some instances, and through the performance of these exemplary operations, executed decomposition engine 146 may “decompose” the structured or unstructured data populating the message fields of RFP message 226 in accordance with field mapping data 138A, and generate the elements of decomposed field data 304 that include, but is not limited to, elements of customer data 306, payment data 308, transaction data 310, and merchant data 312.

By way of example, and based on the elements of field mapping data 138A, executed decomposition engine 146 may determine that message fields 232 of RFP message 226 includes data that identifies and characterizes user 101, and may perform operations that obtain, from message fields 232, a customer name of user 101 (e.g., “John Q. Stone”) and a customer address of user 101 (e.g., “2223 Eye Street NW, Washington, D.C., 20037, US”). Further, as illustrated in FIG. 3A, executed decomposition engine 146 may package the obtained customer name and address into corresponding portions of customer data 306.

Further, based on the elements of field mapping data 138A, executed decomposition engine 146 may determine that message fields 228 and 234 of RFP message 226 include data identifying respective ones of the requested payment date and the payment instrument selected by user 101 to fund the purchase transaction. In some instances, executed decomposition engine 146 may perform operations that obtain, from respective ones of message fields from message fields 228 and 234, the requested payment date of Dec. 15, 2021 and the information that identifies the selected payment instrument (e.g., the account number “XXXX-1234-5678-9012”), which executed decomposition engine 146 may package into corresponding portions of payment data 308. Executed decomposition engine 146 may also determine, based on the elements of field mapping data 138A, that message fields 230 of RFP message 226 include data identifying the requested payment amount and the currency associated with that requested payment amount. In some instances, executed RTP engine 216 may perform operations that obtain, from respective ones of message fields 230, data that identifies the $100.00 requested payment amount and the requested denomination in U.S. currency, and package the obtained data within corresponding portions of transaction data 310.

In some instances, and based on the elements of field mapping data 138A, executed decomposition engine 146 may determine that message fields 236 and 238 include data that identifies and characterizes merchant 111, and that identifies the financial services account associated with merchant 111 and that is capable of receiving proceeds from the purchase transaction. Executed decomposition engine 146 may perform operations that obtain, from message fields 236, a name of merchant 111 (e.g., “Foggy Bottom Running”) and a postal address associated with merchant 111 (e.g., “2001 Pennsylvania Street NW, Washington, D.C., 20037, US”), and that obtain, from message field 238, the information identifying the financial services account associated with merchant 111 (e.g., the account number “XXXX-9012-3456-7890” of the merchant account). Further, executed decomposition engine 146 may perform additional operations that package the obtained merchant name, the obtained merchant address, and the obtained information identifying the merchant account into corresponding portions of merchant data 312 (e.g., merchant name 312A, merchant address 312B).

Additionally, and as described herein, executed decomposition engine 146 may also determine, based on the elements of field mapping data 138A, that message field 244 of RFP message 226 includes structured or unstructured elements of remittance data that characterizes further the initiated purchase transaction, user 101, or merchant 111, and executed decomposition engine 146 may obtain the structured or unstructured elements remittance data from message field 244 and package the obtained elements of remittance data into corresponding portions of remittance information 314. For example, the elements of structured or unstructured remittance data may include the long-form URL that points to formatted receipt data 240 maintained within data repository 220 and that includes contact information of merchant 111 (e.g., address, phone number, web address, etc.), and executed decomposition engine 146 may obtain the long-form URL from message field 244 of RFP message 226, and package that long-form URL into remittance information 314.

In some instances, the one or more processors of FI computing system 130 may execute a remittance analysis engine 336, which may perform operations that, based on the long-form or shortened URL maintained within remittance information 314 of decomposed field data 304, programmatically access elements of formatted receipt data 240 maintained at Merchant computing system 110 of the second financial institution, and that process the accessed elements of formatted receipt data 240 to obtain additional, or alternate, elements of customer data 306, payment data 308, transaction data 310, and merchant data 312. For example, remittance analysis engine 336 may access the long-form or shortened URL maintained within remittance information 214 (e.g., the short- or long-form URL described herein, etc.), and may process URL 215 and generate a corresponding HTTP request 338 for the elements of formatted receipt data 240 maintained at Merchant computing system 110. Executed remittance analysis engine 336 may also perform operations that cause FI computing system 130 to transmit HTTP request 338 across network 120 to Merchant computing system 110.

Merchant computing system 110 may, for example, receive HTTP request 338, and based on portions of HTTP request 338 and linking data 242 (e.g., based on a determined match or correspondence between the portions of HTTP request 338 and linking data 242), Merchant computing system 110 may perform operations that obtain the elements of formatted receipt data 240 from data repository 220, and that transmit the elements of formatted receipt data 240 across network 120 to FI computing system 130, e.g., as a response to HTTP request 338. Further, as illustrated in FIG. 3A, executed remittance analysis engine 336 may receive the elements of formatted receipt data 240 from Merchant computing system 110, and may perform any of the exemplary processes described herein to parse the elements of formatted receipt data 240 (e.g., in a received format, such as a PDF or HTML form, or in a transformed or enhanced format, etc.) and obtain, from the parsed elements of formatted receipt data 240 , one or more of the additional, or alternate, elements of customer data 306, payment data 308, transaction data 310, or merchant data 312. By way of example, executed remittance analysis engine 336 may apply one or more optical character recognition (OCR) processes or optical word recognition (OWR) processes to the elements of formatted receipt data 240 in PDF form to generate, or obtain, elements of textual content representative of the data that characterize user 101, the second financial institution, the loan product issued by the second financial institution, or the requested payment.

By way of example, executed remittance analysis engine 336 may perform operations that detect a presence one or more keywords within the generated elements of textual content (e.g., “UPC,” “address,” “subtotal,” etc.), and may extract elements of the textual content associated with these keywords as corresponding ones of the additional, or alternate, elements of customer data 306, payment data 308, transaction data 310, or merchant data 312. In other examples, executed remittance analysis engine 336 may detect a presence of the additional, or alternate, elements of customer data 306, payment data 308, transaction data 310, or merchant data 312 within the generated textual content based on an application of one or more adaptively trained machine learning or artificial intelligence models to portions of the textual content, and examples of these adaptively trained machine learning or artificial intelligence models includes a trained neural network process (e.g., a convolutional neural network, etc.)or a decision-tree process that ingests input datasets composed of all, or selected portions, of the textual content. The disclosed embodiments are, however, not limited to exemplary processes for detecting and extracting one or more of the additional, or alternate, elements of customer data 306, payment data 308, transaction data 310, or merchant data 312 from the generated textual content, and in other instances, executed remittance analysis engine 336 may perform any additional, or alternate, process for identifying one or more of the additional, or alternate, elements of customer data 306, payment data 308, transaction data 310, or merchant data 312 within the textual content derived from the processing of the elements of formatted receipt data 240 in PDF format.

Further, and as described herein, the elements of formatted receipt data 240 may be structured in HTML form, and may include metadata that identify and characterize user 101 (e.g., the customer name, etc.), the second financial institution (e.g., the name or other identifier, etc.), the requested payment (e.g., a payment amount, etc.), or the loan product issued by the second financial institution (e.g., an interest rate, an amount of remaining principal, etc.). Executed remittance analysis engine 336 may perform operations that detect one or more of the elements of metadata within the elements of formatted receipt data 240 , and that obtain, from the elements of metadata, additional, or alternate, elements of customer data 306, payment data 308, transaction data 310, or merchant data 312, as described herein. The disclosed embodiments are, however, not limited to these exemplary processes for detecting and extracting the additional, or alternate, elements of customer data 306, payment data 308, transaction data 310, or merchant data 312 from HTML-formatted receipt data, and in other instances, executed remittance analysis engine 336 may perform any additional, or alternate, process detecting and obtaining data from the elements of formatted receipt data 240 structured in HTML form, including, but not limited to, an application of one or more screen-scraping processes to portions of formatted receipt data 240 structured in HTML form.

The disclosed embodiments are, however, not limited to elements of structured or unstructured remittance data that include a long-form or shortened URLs pointing to formatted receipt data maintained within data repository 220 of merchant computing system 110. In other instances, the structured or unstructured remittance data maintained within message field 244 of RFP message 226 (or within additional, or alternate, message fields of RFP message 226) may include an additional, or alternate, long-form URL pointing to formatted receipt data maintained at merchant computing system 110 or at other computing systems within environment 100, a shortened URL (e.g., a tiny URL) actionable by FI computing system 130 and pointing to formatted receipt data maintained at merchant computing system 110 or at other computing systems within environment 100, or other elements of data that identify or characterize user 101, merchant 111, or the purchase transaction, such as UPCs of the running shoes or socks.

In some instances, executed decomposition engine 146 may perform operations that store decomposed field data 304, which includes the element of customer data 306, payment data 308, transaction data 310, merchant data 312, and remittance information 314, within a corresponding portion of data repository 134, such as within an element 315 of RTP data store 142. In some examples, data repository 134 further stores other information characterizing customers of the financial institution, such as, but not limited to, profile data that characterizes each of the customers (e.g., values of demographic parameters of the customers, financial or budgetary goals of the customer, such as an expected cost of a future vacation or a desired balance of a savings account, etc.), account data that identifies and characterizes a status of balance of one or more financial accounts held by the customers, and transaction data that characterizes prior deposit or purchase transactions involving the customers of the financial institution.

Executed decomposition engine 146 may also access RFP queue 136, and determine whether RFP queue 136 includes additional RFP messages awaiting decomposition (not illustrated in FIG. 3A). For example, FI computing system 130 may receive additional RFP messages, and may store these additional RFP messages within RFP queue 136 on a continuous and ongoing basis (e.g., throughout each day). If the executed decomposition engine 146 were to determine that additional RFP messages within RFP queue 136 await processing, executed decomposition engine 146 may obtain one of the additional RFP messages, and perform any of the exemplary processes described herein to decompose the message fields of the obtained, additional RFP message in accordance with the elements of field mapping data 138A, to obtain corresponding elements of customer data, payment data, transaction data, merchant data, and remittance information, and to package the customer data, payment data, transaction data, merchant data, and remittance information into additional, decomposed field data for storage within an element of RFP data store 142.

In some examples, illustrated in FIG. 3A, executed decomposition engine 146 may provide decomposed field data 304 as an input to analytical engine 148 of FI computing system 130. Upon execution by the one or more processors of FI computing system 130, executed analytical engine 148 may perform any of the exemplary processes described herein to determine a real-time score of a current financial health and financial well-being of the customer (e.g., user 101) based on portions of decomposed field data 304, either alone or in conjunction with additional data associated with user 101, client device 102, or previously initiated transactions involving user 101 and client device 102. The generated real-time score may, in some instances, reflect an impact of the initiated purchase transaction characterized by decomposed field data 304 on the current financial health and financial well-being of the customer, and may be provisioned to client device 102 in real-time and contemporaneously with the initiation of the purchase transaction and the receipt of RFP message 226.

For example, a transactional metric analysis module 316 of executed analytical engine 148 may receive decomposed field data 304, and may perform operations that access customer data 306 within decomposed field data 304, and a unique customer identifier of the customer, such as customer identifier 208 of user 101 (e.g., a name of user 101, an alphanumeric login credential of user 101, etc.). Further, executed transactional metric analysis module 316 may obtain elements of transaction data 310 maintained within decomposed field data 304, which characterize values of transaction parameters of the initiated purchase transaction, and further, may parse the elements of decomposed field data maintained with RTP data store 142, and identify a subset 317 of the elements of decomposed field data that include, or reference, customer identifier 208 and that characterize additional, or alternative, real-time purchase transactions, payment transaction (e.g., peer-to-peer payments, etc.), or payroll events involving user 101 during a current or one or more prior temporal intervals. As described herein, each of the additional, or alternate, real-time purchase transactions, payment transaction, or payroll events may be associated with an inflow of funds into a financial account of user 101 (e.g., payroll events, proceeds from real-time purchase or payment transactions, etc.) or with an outflow of funds into a financial account of user 101 (e.g., funds debited for approved, real-time payments, etc.).

In some instances, based on decomposed field data 304, and based on subset 317 of the elements of decomposed field data associated with user 101, executed transactional metric analysis module 316 may determine values of one or more transactional metrics that characterize a spending, savings, or other transaction-related behavior of user 101. For example, executed transactional metric analysis module 316 may perform operations that access elements of customer profile data 1406 that include, or reference, customer identifier 208. As described herein, the obtained elements of customer profile data 140B associated with user 101 may include, but are not limited to, values of one or more demographic characteristics of user 1021 (e.g., a customer age, residence, occupation, etc.) and values of one or more budgetary or financial goals of user 101 (e.g., a customer-specified goal to save $3,000 over the next six months to fund a planned vacation to a theme park, a customer-specific goal to cap spending on unscheduled purchase to $25 per day, etc.).

Further, executed transactional metric analysis module 316 may perform operations that process decomposed field data 304, and subset 317 of the additional elements of decomposed field data associated with user 101, that identify one or more existing obligations associated with user 101 (e.g., a mortgage or rent payment, a scheduled credit card payment, etc.), and that generate elements of obligation data 319A that characterize each of the existing obligations. For example, the elements of obligation data 319A may include, for a particular one of the existing obligations, an identifier of a corresponding counterparty (e.g., merchant 111, a financial institution, a management company, etc.), a frequency of the scheduled payments (e.g., monthly, weekly, daily, etc.), scheduled payment amounts, and terms and conditions of the obligation and/or scheduled payment (e.g., a principal or total amount of the obligation on a real-time or time-evolving basis, an interest rate, a contribution of the payment to principal or interest, a current payoff date, etc.).

Executed transactional metric analysis module 316 may also perform operations that, based on decomposed field data 304 and on subset 317 of the elements of decomposed field data associated with user 101, identify one or more payroll events involving user 101, and generate elements of payroll data 319B that characterize the identified payroll events. For example, one of the additional elements of decomposed field data (e.g., as maintained within subset 317) may characterize a direct deposit of funds checking account of user 101 held at a financial institution, and the elements of payroll data 319B associated with the direct payroll deposit may specify, among other things, the deposit amount, a counterparty to the payroll events (e.g., an employer, a payroll provider, etc.), and a date of the deposit. Executed transactional metric analysis module 316 may also generate additional elements of payroll data 319B that specify a frequency of the payroll events involving user 101 (e.g., weekly, monthly, bi-monthly, etc.).

In some instances, based on decomposed field data 304 and subset 317 of the elements of decomposed field data associated with user 101, and based on the elements of obligation data 319A and payroll data 319B associated with user 101, executed transactional metric analysis module 316 may determine customer-specific values of one or more transactional metrics that characterize a spending, savings, or transactional behavior of the customer, either in real-time or over predetermined temporal intervals. Examples of the predetermined temporal intervals include, but are not limited to, a prior business day, a prior week, or a prior month, and executed transactional metric analysis module 316 may package the customer-specific values of the one or more transactional metrics within transactional metric data 318A.

For example, the transactional metrics may include, but are not limited to, an average payroll deposit amount received by the user 101's financial accounts on a daily, weekly, yearly, or monthly basis, and additionally, or alternatively, an average amount saved by user 101 (e.g., as a difference between the payroll deposit amount and the payment amounts over a particular temporal interval) on a daily, weekly, monthly, or yearly basis. In other examples, the transactional metrics may include, but are not limited to, an average value of all payments requested from user 101 on a daily, weekly, monthly, or yearly basis, or value of payment requested by particular merchants during these during these intervals, (e.g., an amount spent on fuel, an amount spent at convenience stores, etc.).

In some examples, executed transactional metric analysis module 316 may also perform any of the exemplary processes described herein to determined group-specific values of these transactional metrics across one or more additional customers of the financial institution that are demographically similar to the customer and as such, establish a peer group that includes the customer, and to generate elements of comparative data that characterize, for example, a comparison of the spending, savings, or transactional behavior of user 101 with that of the peer group. As described herein, the customer-specific values of these transactional metrics may provide the financial institution with insights regarding the financial health or well-being of user 101, and when compared within similar group-specific values of the transactional metrics characterizing those additional, demographically similar customers (e.g., within a common peer group), enable the financial institution to compare the customer's spending, savings, or transactional behavior or habits with similar behaviors or habits of the customer's peer group. Executed transactional metric analysis module 316 may package these group-specific transactional metric values and/or comparative data within portions transactional metric data 318A, and provides transactional metric data 318A, and the elements of obligation data 319A and payroll data 319B, to each of an cashflow metric analysis module 320 and a profile analysis module 322 of executed analytical engine 148.

Executed cashflow metric analysis module 320 may receive transactional metric data 318A and the elements of obligation data 319A and payroll data 319B, and may perform any of the exemplary processes described herein to compute a value of one or more cashflow metrics that characterize user 101 and the financial accounts of user 101 based on transactional metric data 318A and the elements of obligation data 319A and payroll data 319B, and in some instances, based on decomposed field data 304 and on subset 317 of the elements of decomposed field data associated with user 101. By way of example, and based on an analysis of decomposed field data 304 and subset 317 of the elements of decomposed field data, in conjunction with transactional metric data 318A, obligation data 319A, and payroll data 319B, executed cashflow metric analysis module 320 may perform operations that compute one or more cashflow metric values that characterize an expected inflow of funds into a financial account of user 101, and further, an expected outflow of funds into a financial account of user 101, during a current temporal interval or one or more future temporal intervals, and may package the computed or generated metric values into a corresponding portion of cashflow metric data 318B, and provides cashflow metric data 318B to profile analysis module 322.

For instance, executed cashflow metric analysis module 320 may determine, based on decomposed field data 304 and on subset 317 of the elements of decomposed field data associated with user, either alone or in conjunction with payroll data 319B, that user 101's financial account receive a deposit of $2,500 every month from a same counterparty (e.g., an employer), and may generate a cashflow metric value characterizing the expected $2,500 deposit and an expected, future date of the deposit. Further, and by way of example, executed cashflow metric analysis module 320 may also determine, based on decomposed field data 304 and on subset 317 of the elements of decomposed field data associated with user, either alone or in conjunction with obligation data 319A, that user 101 customer pays, from a corresponding financial account, $1,500 every month to a counterparty (e.g., a financial institution) for a mortgage payment, and may generate a cashflow metric value characterizing the expected $1,500 payment and an expected date of the payment.

Further, and as described herein, executed cashflow metric analysis module 320 may perform operations that generate cashflow metric values characterizing either an expected inflow of funds into user 101's financial accounts, or an expected outflow of funds from user 101's financial accounts, across one or more future temporal intervals, such as an upcoming week, an upcoming month, or an upcoming financial quarter. In some instances, and based on the expected inflow of funds and outflow of funds, executed cashflow metric analysis module 320 determines a current (e.g., real-time), or an expected, amount of excess funds available within the customer's financial account. For example, executed cashflow metric analysis module 320 may compare the cashflow metric value characterizing the expected inflow of funds to the cashflow metric value characterizing the expected outflow of funds to generate a cashflow metric value characterizing the current, or expected, amount of excess funds available within the customer's financial account.

In some instances, the computation of the cashflow metric values by executed cashflow metric analysis module 320 may be informed by one or more budgetary or financial goals of the customer. For example, executed cashflow metric analysis module 320 may obtain one or more elements of customer profile data 1406 that includes, or references, customer identifier 208, and that identify and characterize user 101 (e.g., as maintained within customer data store 140). The obtained elements of customer profile data 140B may reflect a budget cap specified by user 101, and in some examples, executed cashflow metric analysis module 320 may adjust the determined amount of excess funds based on the budget cap indicated by the customer profile data 140B. Additionally, in some examples, the obtained elements of customer profile data 140B may identify a particular savings goal specified by user 101, and executed cashflow metric analysis module 320 may adjust the determined amount of excess funds based the particular savings goal.

As illustrated in FIG. 3A, executed cashflow metric analysis module 320 may package the generated cashflow metric values within portions of cashflow metric data 318B, and may provide cashflow metric data 318B to profile analysis module 322 of executed analytical engine 148. In some instances, based on transactional metric data 318A and cashflow metric data 318B, executed profile analysis module 322 may generate elements of risk profile data 318C that includes a real-time indicator of a current financial health and financial well-being of user 101. The real-time indicator may include a numerical score (e.g., real-time, numerical score), and in some instances, the numerical score may characterize a likelihood of an occurrence of one or more events indicating, to the financial institution, the financial health and well-being of the customer. For example, the one or more events may, for example, be associated with amount of excess funds available within the customer's financial accounts, and the numerical score may range from zero to unity, with a score of unity indicating a maximum of financial health and well-being (e.g., an occurrence of a maximum of excess funds), a score of zero indicating a minimum of financial health and well-being (e.g., an occurrence of deficit in excess funds), and a score of 0.5 indicating a balance between the customer's daily earning and expected daily payments (e.g., an occurrence an absence of excess funds). In other instances, the numerical score associated with the real-time indicator may also characterize the financial health and well-being of the customer in relation to a determine adherence to one or more customer-specified financial or savings goals (e.g., an occurrence of a corresponding event, etc.) characterized within customer profile data 140B (e.g., a score of unity may indicate complete compliant with a specified budget, while a score of zero may indicate a minimum compliance).

In some instances, and to determine the value of the real-time indicator of the current financial health and financial well-being of user 101, executed profile analysis module 322 may perform operations that apply a trained machine learning or artificial intelligence process to a corresponding input dataset obtained, or extracted from, portions of transactional metric data 318A and the cashflow metric data 318B, and in some instances, based on decomposed field data 304 and subset 317 of the elements of decomposed field data associated with user 101. Based on the application of the trained machine learning or artificial intelligence process to the corresponding input dataset, executed profile analysis module 322 may predict the value of the real-time indicator of the current financial health and financial well-being of user 101.

Examples of the trained machine-learning and artificial-intelligence processes may include, but are not limited to, a clustering process, an unsupervised learning process (e.g., a k-means algorithm, a mixture model, a hierarchical clustering algorithm, etc.), a semi-supervised learning process, a supervised learning process, or a statistical process (e.g., a multinomial logistic regression model, etc.). The trained machine-learning and artificial-intelligence processes may also include, among other things, a decision tree process (e.g., a boosted decision tree algorithm, etc.), a random decision forest, an artificial neural network, a deep neural network, or an association-rule process (e.g., an Apriori algorithm, an Eclat algorithm, or an FP-growth algorithm). Further, and as described herein, each of these exemplary machine-learning and artificial-intelligence processes may be trained against, and adaptively improved using, elements of training and validation data, and may be deemed successfully trained and ready for deployment when a value of one or more performance or accuracy metrics are consistent with one or more threshold training or validation criteria.

For instance, the trained machine learning or artificial intelligence process may include a trained decision-tree process, and executed profile analysis module 322 may obtain, from one or more tangible, non-transitory memories, elements of process input data and process parameter data associated with the trained decision-tree process (not illustrated in FIG. 3A). For example, the elements of process input data may characterize a composition of the input dataset for the trained decision-tree process and identify each of the discrete data elements within the input data set, along with a sequence or position of these elements within the input data set, and the elements of process parameter data may include a value for one or more parameters of the trained decision-tree process. Examples of these parameter values include, but are not limited to, a learning rate associated with the trained, decision-tree process, a number of discrete decision trees included within the trained, decision-tree process, a tree depth characterizing a depth of each of the discrete decision trees, a minimum number of observations in terminal nodes of the decision trees, and/or values of one or more hyperparameters that reduce potential process overfitting.

In some examples, not illustrated in FIG. 3A, executed profile analysis module 322 may perform operations that generate one or more discrete elements (e.g., “feature values”) of the input dataset in accordance with the elements of process input data and based on the portions of portions of transactional metric data 318A and the cashflow metric data 318B, and in some instances, based on decomposed field data 304 and subset 317 of the elements of decomposed field data associated with user 101. Based on portions of the process parameter data, executed profile analysis module 322 may perform operations that establish a plurality of nodes and a plurality of decision trees for the trained decision-tree process, each of which receive, as inputs (e.g., “ingest”), corresponding elements of the input dataset. Further, and the ingestion of the input dataset by the established nodes and decision trees of the trained decision-tree process, executed profile analysis module 322 may perform operations that apply the trained, decision-tree process to the input dataset, and that generate the value of the real-time indicator of the current financial health and financial well-being of user 101.

Further, in some examples, based on the transaction and cashflow metric values included within respective ones of transactional metric data 318A and the cashflow metric data 318B, and in some instances, based on decomposed field data 304 and subset 317 of the elements of decomposed field data associated with user 101, executed profile analysis module 322 may determine, among other things, a portion of a salary of user 101 earned on a daily basis (e.g., based on daily payroll events, or more temporally coarse payroll events averaged on a daily basis), or an amount user 101 is expected to owe in payments to one or more counterparties on a daily basis (e.g., based on portions of decomposed field data 304 and subset 317 of the elements of decomposed field data requesting daily payments, or more temporally coarse payment events averaged on a daily basis). Although not illustrated in FIG. 3A, executed profile analysis module 322 may package information characterizing the portion of the salary of user 101 earned on a daily basis and the amount user 101 is expected to owe in payments to one or more counterparties on a daily basis into corresponding portions of risk profile data 318C.

As illustrated in FIG. 3A, executed analytical engine 148 packages all, or a selected portion of, the transactional metric 318A, cashflow metric data 318B, and risk profile data 318C (including the numerical value of the real-time indicator) into metric data 334, and provides the metric data 334 to notification engine 150. Upon execution by the one or more processors of FI computing system 130, executed notification engine 150 may perform any of the exemplary processes described herein to generate elements of notification data that identify, and characterize one or more of the customer- or group-specific values of transactional metrics included within transactional metric data 318A, one or more of the values of cashflow metrics included within cashflow metric data 318B, and portion of risk profile data 318C (e.g., the real-time, numerical score) of user 101.

In some examples, as described herein, executed analytical engine 148 may perform any of the exemplary processes described herein to determine one or more customer- or group-specific values of transactional metrics, to determine one or more values of cashflow metrics, and to determine a numerical score characterizing a current financial condition or financial health of user 101, in real-time and contemporaneously with a receipt of RFP message 226, and with a generation and decomposed field data 304. In other examples, described herein in reference to FI. B, the determination of the or more customer- or group-specific values of transactional metrics, the one or more values of cashflow metrics, and the numerical score characterizing the current financial condition or financial health of user 101 by executed analytical engine 148 may be triggered not by the receipt and decomposition of RFP message 226, but instead based on a receipt of requested data generated by one or more application programs executed by client device 102, such as mobile banking application 108.

Referring to FIG. 3B, in some examples, the one or more processors of client device 102, including processor 104, may execute mobile banking application 108, which may perform operations that obtain a customer identifier of user 101, such as customer identifier 208, and package customer identifier 208 into corresponding portions of a request 340 for data charactering the financial health and well-being of user 101. In some instances, mobile banking application 108 may generate request 340 in accordance with a predetermined schedule (e.g., on a daily basis, etc.), in response to input provided to client device 102 by user 101 (e.g., via input unit 109B) or in response to a detection of an occurrence of a triggering event (e.g., a receipt of a payment notification from FI computing system 130, etc.). Executed mobile banking application 108 may perform operations that cause client device 102 to transmit request 340, including customer identifier 208, across network 120 to FI computing system 130.

A programmatic interface established and maintained by FI computing system 130, such as API 342, may receive request 340, and may route request 340 to a request processing module 344 of executed analytical engine 148. Request processing module 366 may parse the request 340 to extract the customer identifier 208, and may provide the customer identifier 208 to executed transactional metric analysis module 316. Based on customer identifier 208, executed transactional metric analysis module 316 may perform any of the exemplary processes described herein to generate and package the customer- and group-specific values of the transactional metrics associated with user 101 into portions of transactional metric data 318A, to generate elements of obligation data 319A and payroll data 319B associated with user 101, and to provision transactional metric data 318A and the elements of obligation data 319A and payroll data 319B as inputs to executed cashflow metric analysis module 320 and to executed profile analysis module 322.

Further, executed cashflow metric analysis module 320 may receive transactional metric data 318A and the elements of obligation data 319A and payroll data 319B, and may perform any of the exemplary processes described herein to generate one or more values of cashflow metrics associated with user 101, and to package the values of the cashflow metrics into corresponding portions of cashflow metric data 318B, which executed cashflow metric analysis module 320 may provide as an input to executed profile analysis module 322. In some instances, executed profile analysis module 322 may receive cashflow metric data 318B (e.g., from cashflow metric analysis module 320), and may receive transactional metric data 318A and the elements of obligation data 319A and payroll data (e.g., from transactional metric analysis module 316). Executed profile analysis module 322 may also perform any of the exemplary processes described herein to generate elements of risk profile data 318C that includes a real-time indicator (e.g., real-time, numerical score) of a current financial health and financial well-being of user 101.

As illustrated in FIG. 3B, executed analytical engine 148 packages all, or a selected portion of, the transactional metric 318A, cashflow metric data 318B, and risk profile data 318C (including the numerical value of the real-time indicator) into metric data 334, and provides the metric data 334 to notification engine 150. Upon execution by the one or more processors of FI computing system 130, executed notification engine 150 may perform any of the exemplary processes described herein to generate elements of notification data that identify, and characterize one or more of the customer- or group-specific values of transactional metrics included within transactional metric data 318A, one or more of the values of cashflow metrics included within cashflow metric data 318B, and portion of risk profile data 318C (e.g., the real-time, numerical score) of user 101.

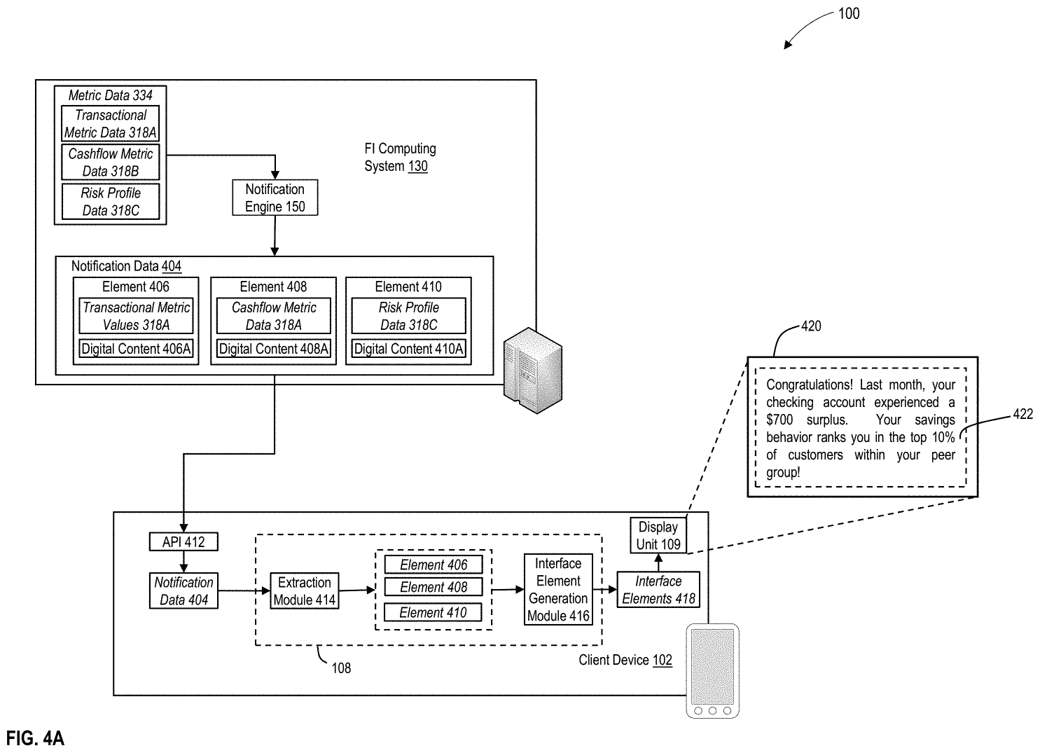

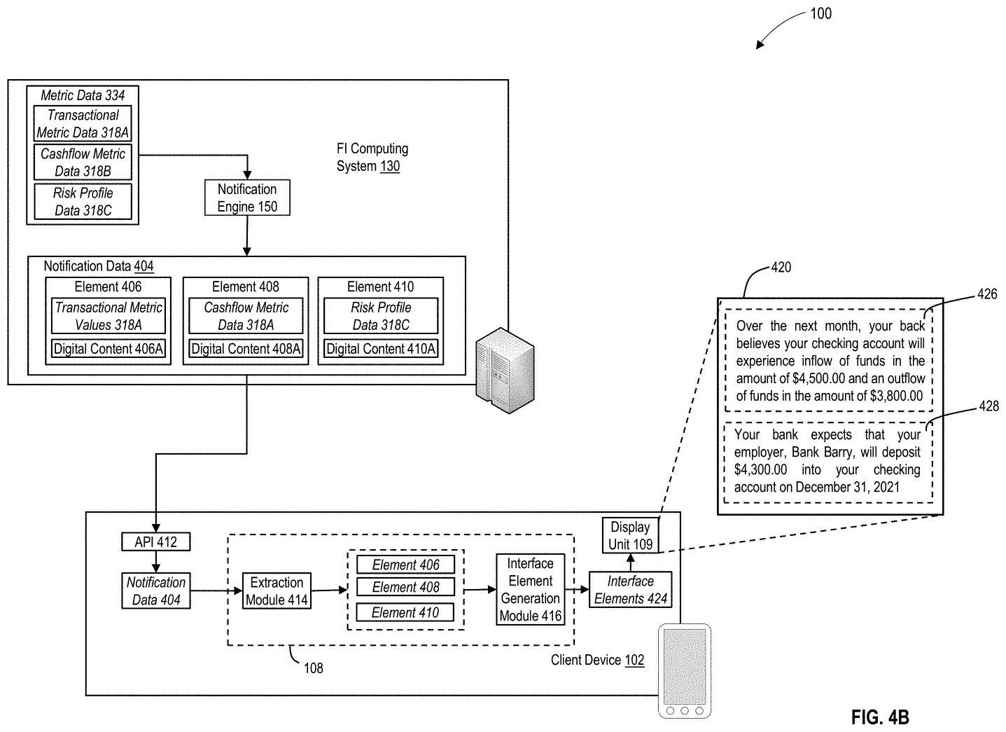

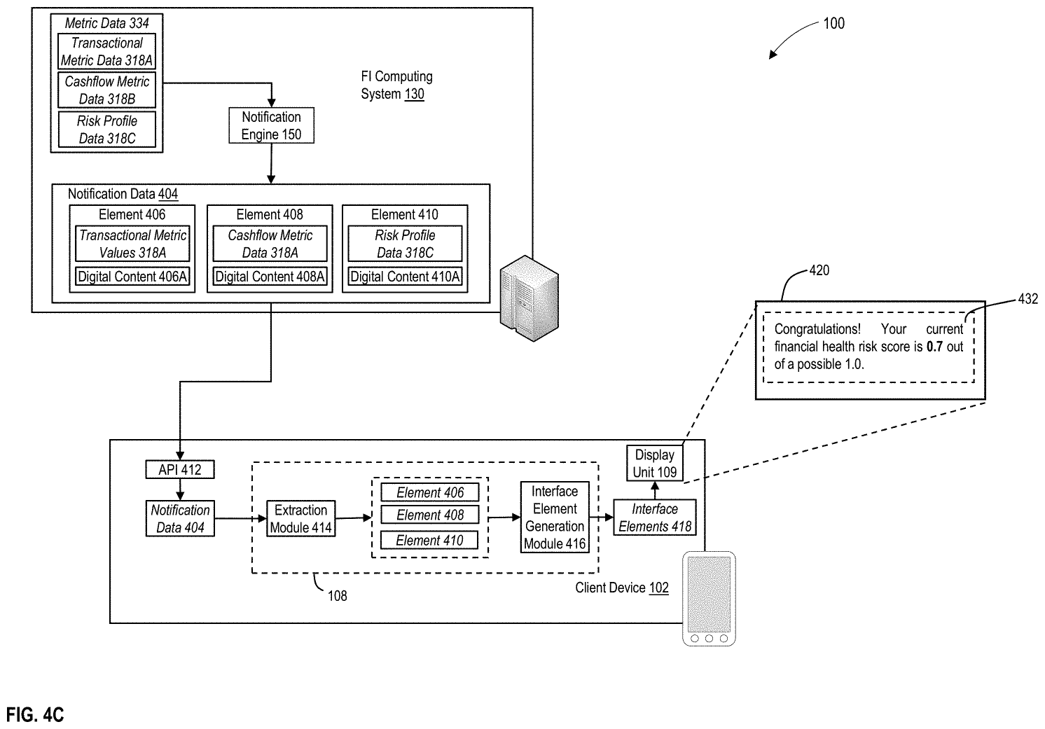

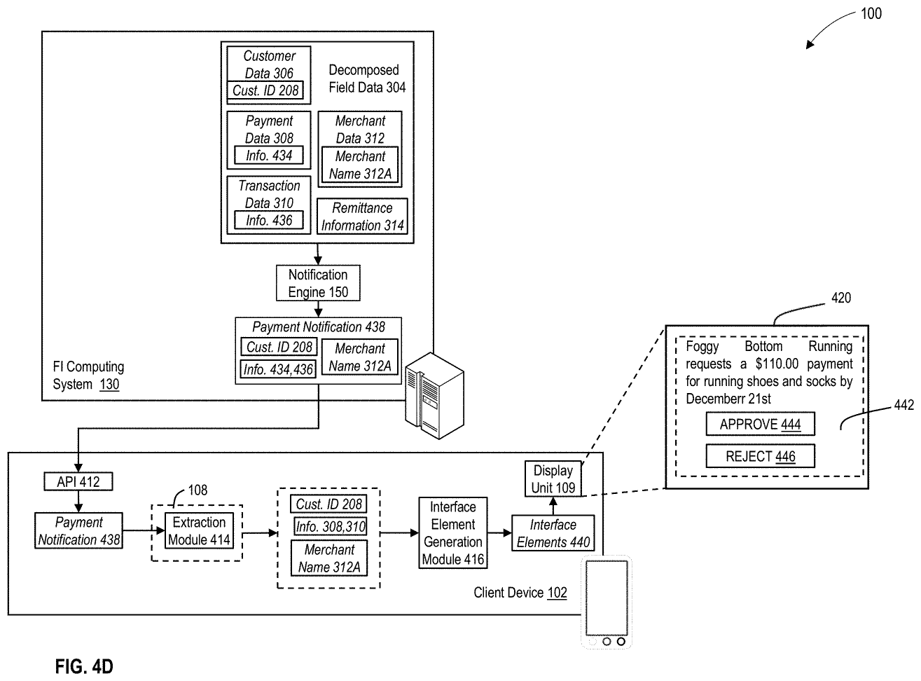

Referring to FIG. 4A, and upon execution by the one or more processors of FI computing system 130, executed notification engine 150 may receive metric data 334, which include transactional metric data 318A specifying one or more the group- or customer-specific values of the transactional metrics associated with user 101, cashflow metric data 318B specifying one or more the values of the cashflow metrics associated with user 101, and risk profile data 318C characterizing risk profile of user 101, including a real-time, numerical value characterizing of the current financial health and financial well-being of user 101. By way of example, the customer- and group-specific transaction metric values associated with user 101, and maintained within transactional metric data 318A, may indicate that user 101, over the past month, experienced a surplus of $700 within a checking account issued by the financial institution (e.g., based on a difference between the expected deposits into the checking account and the expected outlays due to obligations, etc.), and that the savings behavior of user 101 (e.g., the $700 surplus) ranks user 101 within the top 10% of a corresponding peer group. In some instances, executed notification engine 150 may package all, or a selected portion of transactional metric data 318A into an element 406 of notification data 404, along with elements of digital content 406A that, when rendered for presentation in a corresponding digital interface by one or more application programs executed at client device 102 (e.g., mobile banking application 108), provide a graphical representation of the relative position of user 101's savings behavior among the corresponding peer group.

Further, the values of the cashflow metric associated with user 101, as maintained within cashflow metric data 318B, may indicate that the financial institution expects that, during the next thirty days, a checking account of user 101 will experience and expected inflow of funds in the amount of $4,500.00 and an expected outflow of funds in the amount of $3,800.00, and that the financial institution expects that an employer of user 101 (e.g., “Bank Barry”) will deposit wages into the amount of $4,300.00 into user 101's checking account on Dec. 31, 2021 (e.g., an occurrence of a payroll event). Executed notification engine 150 may package all, or a selected portion of cashflow metric data 318B into an element 408 of notification data 404, along with elements of digital content 408A that, when rendered for presentation in a corresponding digital interface by one or more application programs executed at client device 102 (e.g., mobile banking application 108), provide a graphical representation of the expected cash inflows, cash outflows, and expected occurrence of a payroll event involving the checking account of user 101.

Additionally, in some instances, risk profile data 318C may include a real-time indicator of a current financial health and financial well-being of user 101, e.g., a real-time, numerical value of 0.7, and executed notification engine 150 may package all, or a selected portion, of risk profile data 318C, including the real-time numerical value of 0.6, into an element 410 of notification data 404, along with elements of digital content 410A that, when rendered for presentation in a corresponding digital interface by one or more application programs executed at client device 102 (e.g., mobile banking application 108), provide a graphical representation of the real-time, numerical value indicating the current financial health and financial well-being of user 101. Executed notification module 150 may perform additional operations that cause FI computing system 130 to transmit notification data 404, including elements 406, 408, and 410, across network 120 to client device 102.

A programmatic interface associated with one or more application programs executed at client device 102, such as an API 412 associated with mobile banking application 108, may receive notification data 404 and perform operations that cause client device 102 to execute mobile banking application 108 (e.g., through a generation of a programmatic command, etc.). Upon execution by the one or more processors of client device 102, executed mobile banking application 108 may receive notification data 404, including elements 406, 408, and 410, from API 422, and an extraction module 414 of executed mobile banking application 108 may parse notification data 404 and obtain each of elements 406, 408, and 410. For example, executed extraction module 414 may provide element 406 of notification data 404 (including transactional metric data 318A and the elements of digital content 406A) as an input to an interface element generation module 416 of executed mobile banking application 108, which may perform operations that generate and route interface elements 418 to display unit 109A. In some instances, when rendered for presentation within a notification interface 420 by display unit 109A, interface elements 418 provide a graphical representation 422 of the relative position of user 101's savings behavior among the corresponding peer group, e.g., within the top 10%.

Referring to FIG. 4B, executed extraction module 414 may provide element 408 of notification data 404 (including cashflow metric data 318B and the elements of digital content 408A) as an input to an interface element generation module 416 of executed mobile banking application 108, which may perform operations that generate and route interface elements 424 to display unit 109A. In some instances, when rendered for presentation within a notification interface 420 by display unit 109A, interface elements 418 provide a graphical representation 426 of the expected inflow of funds in the amount of $4,500.00 and an expected outflow of funds in the amount of $3,800.00, and a graphical representation 428 of the expected, $4,300.00 payroll deposit into user 101's checking account on Dec. 31, 2021. Finally, referring to FIG. 4C, executed extraction module 414 may provide element 410 of notification data 404 (including risk profile data 318C and the elements of digital content 410A) as an input to an interface element generation module 416 of executed mobile banking application 108, which may perform operations that generate and route interface elements 430 to display unit 109A. In some instances, when rendered for presentation within a notification interface 420 by display unit 109A, interface elements 430 provide a graphical representation 432 of the real-time numerical score of 0.7, characterizes the current financial health and financial well-being of user 101, as described herein.

In some examples, described herein in reference to FIG. 4D, executed notification engine 150, which may perform any of the exemplary processes described herein to generate, and provision to client device 102, a payment notification associated with the $110.00 payment requested from user 101 by merchant 11 (e.g., “Foggy Bottom Running”) for the purchased running shoes and socks. Referring to FIG. 4D, executed notification engine 150 may access decomposed field data 304 (e.g., as maintained within element 315 of RPA data store 142) generate a payment notification 438 based on one or more data elements of decomposed field data 304. For example, executed notification engine 150 may perform operations to parse customer data 306 within decomposed field data 304 to obtain the customer identifier 208 of user 101, that parse payment data 308 to obtain payment information 434 that identifies the payment amount (e.g., the requested $110.00 payment amount) and the requested payment date (e.g., a Dec. 21, 2021), that parse transaction data 210 to obtain transaction information 436 that identifies the purchased running shoes and socks, and that parse merchant data 312 to obtain merchant name 212A (e.g., “Foggy Bottom Running”). Executed notification engine 150 may perform additional operations that generate a payment notification 438 that includes the customer identifier 208, the portion of payment information 434 that specifies the $110.00 payment amount and a requested payment date (e.g., December 21^{st}), the portion of transaction information 436 that identifies the purchased running shoes and socks, and merchant name 312A, and transmit payment notification 438 across network 120 to client device 102.

API 412 of client device 102 may receive payment notification 438 and route payment notification 438 to executed mobile banking application 108. As described herein, an executed extraction module 414 may receive payment notification 438, and perform operations that parse payment notification 438 to obtain the customer identifier 208, the portion of payment information 434 and transaction information 436, and merchant name 312A, which executed extraction module 414 may provide as an input to executed interface element generation module 416. In some instances, executed interface element generation module 416 may perform operations that generate one or more interface elements 440 based on customer identifier 208, the portion of payment information 434 and transaction information 436, and merchant name 312A, and provide interface elements 440 to display unit 109A. When rendered for presentation within notification interface 420 by display unit 109A, interface elements 440 provide a graphical representation 442 of the request for payment within a single display screen or window, or across multiple display screens or windows, of notification interface 420.

For example, interface elements 440 may, when presented within notification interface 420, provide a graphical representation of the request for the $110.00 payment from user 101 by Foggy Bottom Running, and prompt user 101 to approve or reject the request for payment, e.g., based on additional input provided to input unit 109B of client device 102 that selects a respective one of an “APPROVE” icon 444 and a “REJECT” icon 446 presented within notification interface 420. User 101 may elect to approve the requested payment (e.g., to send payment to the second financial institution) by providing input (e.g., via input unit 109B) to select the “APPROVE” icon 444, or may decline the requested payment by providing input to select the “REJECT” icon 446, and client device 102 may perform operations that generate and one or more elements of a payment response indicative of the approved or decline payment, and that transmit the payment response across network 120 to FI computing system 130 (not illustrated in FIG. 4D).

In some instances, user 101 may elect to approve the $110.00 payment requested by merchant 111 for the purchase of the running shoes and socks, and user 101 may provide input to client device 102 (e.g., via input unit 109B) that selects “APPROVE” icon 444. Based on the input, executed mobile banking application 108 may perform operations (not illustrated in FIG. 4D), that generate and transmit a confirmation of the approved payment across network 120 to FI computing system 130, which may perform operations that, in real-time, debit the $110.00 from an account held by user 101 and associated with the selected payment instrument, and that credit the $110.00 to the financial services account associated with merchant 111 and specified within RFP message 226 (e.g., either directly, if the financial institution issues the financial services account associated with merchant 111, or based on additional ISO-20022-compliant RTP messages exchanged with computing systems associated with other financial institution). FI computing system 130 may also perform operations that access RFP message 226 maintained within RFP queue 136, and delete RFP message 226 from RFP queue 136, e.g., based on the approval by user 101 and the real-time clearance and settlement of the approved payment.

Further, FI computing system 130 may also perform operations that transmit one or more messages to merchant computing system 110 that confirm the approval of the requested payment by user 101 and the real-time clearance and settlement of the approved payment, either directly across network 120 or through one or more of computing systems or devices 246 associated with participants in the RTP ecosystem (e.g., additional ISO-20022-compliant messages, etc.). Based on the one or more messages, merchant computing system 110 may perform operations that enable merchant 111 to execute the initiated purchase transaction and provision the purchased large coffee and blueberry muffin to user 101.

In other instances, and based on confirmation data indicating a rejection by user 101 of the requested payment (e.g., based on additional input selecting “REJECT” icon 446, FI computing system 130 may perform operations that delete RFP message 226 from RFP queue 136, and generate and transmit one or more messages to merchant computing system 110 indicative of the rejected payment, either directly across network 120 or through one or more of computing systems or devices 246 associated with participants in the RTP ecosystem (e.g., additional ISO-20022-compliant messages, etc.). Based on the indication of the rejection of the requested payment by user 101 (e.g., due to potential fraud, etc.), merchant computing system 110 may perform operations that enable merchant 111 to cancel the initiated purchase transaction in real-time and without delays and chargebacks characteristic of the transaction reconciliation, clearance, and settlement processes involving payment rails and transaction processing-messages.

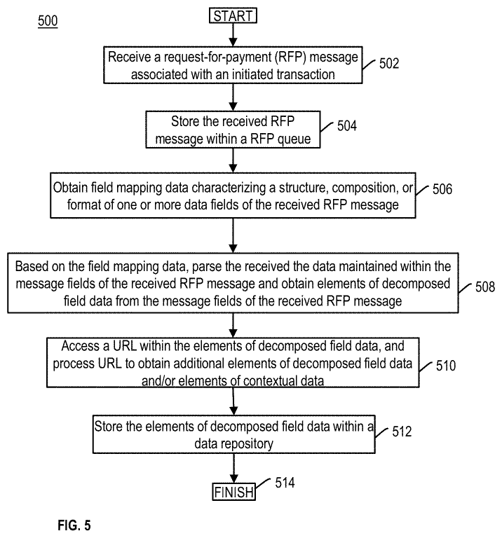

FIG. 5 is a flowchart of exemplary process 500 for decomposing a request-for-payment (RFP) message formatted and structured in accordance with one or more standardized data-exchange protocols, in accordance with some exemplary embodiments. For example, one or more computing systems associated with a financial institution, such as FI computing system 130, may perform one or more of the steps of exemplary process 500. Referring to FIG. 5, FI computing system 130 may perform any of the processes described herein to obtain a RFP message associated with the initiated exchange of data (e.g., in step 502 of FIG. 5). As described herein, the data exchange may include, but is not limited to, a purchase transaction initiated between a first counterparty (e.g., a merchant, such as the merchant associated with merchant computing system 110) and a second counterparty (e.g., a customer of the merchant, such as user 101 associated with client device 102), and the purchase transaction may involve, or be associated with one or more products or services provisioned by the first counterparty to the second counterparty.

The RFP message may be generated by merchant computing system 110 using any of the exemplary processes described herein, and in some instances, FI computing system 130 may receive the RFP message directly from merchant computing system 110 across a corresponding communications network (e.g., communications network 120), or may receive the RFP message from via one or more intermediate computing systems, such as, but not limited to, as a computing system associated with the financial institution of the merchant or one or more computing systems of a clearinghouse associated with the RTP ecosystem. In other instances, the RFP message may be generated by one of intermediate computing systems, such as the computing system associated with the financial institution of the merchant or the one or more computing systems of the clearinghouse, based on elements of data characterizing the purchase transaction and generated by merchant computing system 110.

As described herein, the received RFP message may include message fields consistent with the ISO 20022 standard for electronic data exchange between financial institutions, and each of the message fields may be populated with data structured and formatted in accordance with the ISO 20022 standard. By way of example, the received, ISO-20022-compliant RFP message may include, among other things, (i) message fields populated with data specifying a full name and postal address of user 101; (ii) message fields populated with data identifying a payment instrument selected by user 101 to fund the initiated purchase transaction; (iii) message fields populated with data specifying a name and postal address of the merchant; (iv) message fields populated with data identifying a financial services account held by the merchant and available to receive processed from the requested payment; and (v) message fields populated with one or more parameter values that characterize the purchase transaction, a requested payment method, and/or a requested payment date. Further, and as described herein, the received, ISO-20022-compliant RFP message may also include structured or unstructured message fields that specify additional remittance information associated with the purchase transaction, and examples of the additional remittance information include, but are not limited to, information identifying a product or service involved in the purchase transaction, or a link to remittance data associated with the initiated transaction (e.g., a long-form URL or shortened to a PDF or HTML invoice, as described herein).

Referring back to FIG. 5, FI computing system 130 may store the received RFP message within a corresponding portion of locally accessible data repository, such as within RFP queue 136 of data repository 134 (e.g., in step 504 of FIG. 5), and may obtain, from the locally accessible data repository, one or more elements of field mapping data that characterize a structure, composition, or format of one or more data fields of the received RFP message (e.g., in step 506 of FIG. 5). Based on the obtained elements of the field mapping data, FI computing system 130 may perform any of the exemplary processes described herein to parse the data maintained within the message fields of the received RFP message, and to obtain elements of decomposed field data that identify and characterize user 101, the merchant, the purchase transaction, and the payment requested from user 101 by the merchant for the purchased products or services (e.g., in step 508 of FIG. 5). For example, the elements of decomposed field data (e.g., decomposed field data 304 of FIG. 2A and 2B) may include, but are not limited to, customer data that identifies a full name or address of user 101 (e.g., customer data 306 of decomposed field data 304), payment data that identifies a requested payment date, a requested payment account, a payment instrument selected by user 101 to fund the purchase transaction, or a (e.g., payment data 308 of decomposed field data 304), transaction data that includes a value of one or more parameters of the transaction, such as a total transaction amount, a transaction subtotal or an imposed local tax, or an identifier of one or more of the purchased products or services (e.g., transaction data 310 of decomposed field data 304), and vendor data that includes a name of the merchant or a postal address associated with the merchant (e.g., merchant data 312 of decomposed field data 304).

Further, and as described herein, the elements of decomposed field data may also include additional elements of structured or unstructured remittance data, such as, but not limited to, a long-form URL or a shortened URL that point to elements of formatted invoice data (e.g., in PDF or HTML form) associated with the initiated purchase transaction and maintained at one or more additional computing systems, such as merchant computing system 110 (e.g., the URL maintained within remittance information 314 of decomposed field data 304). In some instances, FI computing system 130 may perform any of the exemplary processes described herein to process the long-form URL or a shortened URL and to obtain (i) additional elements of decomposed field data that identify and characterize user 101, the merchant, the initiated purchase transaction, and the payment requested from user 101 by the merchant for the purchased products or services, and/or (ii) elements of contextual data that further characterize user 101, the merchant, the initiated purchase transaction, or the payment requested (e.g., in step 510 of FIG. 5). FI computing system 130 may also perform operations, described herein, that store the additional elements of decomposed field data and/or the elements of contextual data within corresponding portions of the decomposed field data.

For example, the long-form URL may include one or more embedded elements of customer data, counterparty data, or transaction data, such as, but not limited to, the postal code of the merchant involved in the initiated purchase transaction and an identifier of the customer. In some instances, FI computing system 130 may perform any of the exemplary processes described herein may parse the long URL to identify and extract one or more of the additional elements of decomposed field data from the long-form URL, and to store the additional elements of decomposed field within the data repository (e.g., in step 510 of FIG. 5). Further, in some examples, FI computing system 130 may perform any of the exemplary processes described herein to process the long- or shortened URL and obtain elements of formatted data associated with the initiated purchase transaction and maintained by a computing system of the merchant, such as formatted receipt data 240 of FIG. 2A (e.g., also in step 510 of FIG. 5).

As described herein, the formatted data may be structured in PDF or HTML format, and FI computing system 130 may perform any of the exemplary processes described herein to may perform operations, described herein to process the elements of formatted data (e.g., through an application of an optical character recognition (OCR) process to the formatted data structured in PDF form, or to parse code associated with, or apply a screen-scraping process to, the formatted data structured in HTML form), and obtain one or more of the additional elements of the decomposed field data and/or the elements of contextual data (e.g., also in step 510 of FIG. 5).

FI computing system 130 may also perform operations, described herein, that store the elements of decomposed field data in a data repository, such as, but not limited to, one or more of the data records of RTP data store 142 of FIG. 1 (e.g., in step 512 of FIG. 5). Exemplary process 500 may then be completed in step 514.

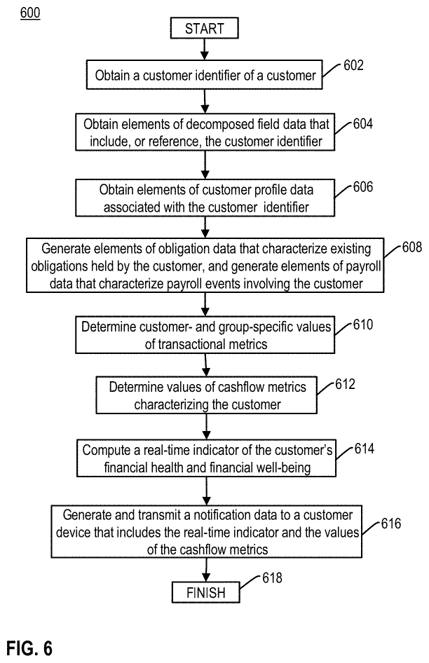

FIG. 6 is a flowchart of an exemplary process 600 for generating real-time insights on customer transactional behavior, financial health, and financial well-being based on real-time-payment (RTP) messages formatted and structured in accordance with one or more standardized data-exchange protocols. For example, one or more computing systems associated with a financial institution, such as FI computing system 130, may perform one or more of the exemplary steps of exemplary process 600. Referring to FIG. 6, FI computing system 130 may perform any of the exemplary processes described herein to obtain a customer identifier of a customer of the financial institution, such as customer identifier 208 of user 101 (e.g., in step 602 of FIG. 6). In some examples, FI computing system 130 may obtain customer identifier from one or more elements of decomposed field data (e.g., from customer data 306 of decomposed field data 304) associated with a received or intercepted RFP message, such as RFP message 226. In other examples, described herein, FI computing system 130 may obtain the customer identifier from elements of request data, such as request 340, generated by one or more application programs executed by client device 102, such as executed mobile banking application 108.

Based on the obtained customer identifier, FI computing system 130 may perform any of the exemplary processes described herein to access a data repository, such as RTP data store 142, and obtain a subset of the stored elements of decomposed field data (e.g., decomposed field data 304 and subset 317, etc.) that include, or reference, the customer identifier, and as such, are associated with the customer (e.g., in step 604 of FIG. 6). Further, and based on the obtained customer identifier, FI computing system 130 may also load, from the data repository, elements of customer profile data (e.g., elements of customer profile data 140B) that include, or reference, the customer identifier and are associated with the customer (e.g., in step 606 of FIG. 6). As described herein, the customer profile data may include, but is not limited to, values of one or more demographic characteristics of the customer (e.g., a customer age, residence, occupation, etc.) and value of one or more budgetary or financial goals of the customer (e.g., a customer-specified goal to save $3,000 over the next six months to fund a planned vacation to a theme part, a customer-specific goal to cap spending on unscheduled purchase to $25 per day, etc.).

In some instances, based on the obtained subset of the stored elements of decomposed field data, FI computing system 130 may perform any of the exemplary operations described herein to generate elements of obligation data that identify and characterize one or more existing obligations associated with the customer, and to generate of payroll data that identify and characterize on or more payroll events involving the customer (e.g., in step 608 of FIG. 1). Further, based on the obtained subset of the stored elements of decomposed field data, and on the elements of payroll and obligation data, FI computing system 130 may perform any of the exemplary operations described herein to, determine customer-specific values of one or more transactional metrics (e.g., transactional metric data 318A) that characterize a spending, savings, or transactional behavior of the customer, either in real-time or over specified temporal intervals, such as a prior business day, a prior week, etc. (e.g., in step 610 of FIG. 1). Based on a performance of any of the exemplary processes described herein, FI computing system 130 may compute one or more group-specific values of these transactional metrics across one or more additional customers of the financial institution that are demographically similar to the customer and, as such, establish a peer group that includes the customer (e.g., also in step 610 of FIG. 6).

FI computing system 130 may also perform any of the exemplary operations described herein to determine a value of one or more cashflow metrics that characterize the customer and the customer's financial accounts based on the elements of real-time transaction data associated with the customer, either alone or in conjunction with the obligation data, the comparative data, the payroll data, and the customer-specific values of the transactional metrics (e.g., in step 612 of FIG. 6). For example, and based on the FI computing system's 130 analysis of the obtained subset of the stored elements of decomposed field data, FI computing system 130 may generate cashflow metric values (e.g., cashflow metric data 318B) that characterize, both in real time and over various temporal intervals, an expected inflow of funds into the customer's financial accounts, an expected outflow of funds from the customer's financial accounts, and as such, an amount of excess funds available within the customer's financial accounts. In other examples, the determination of the cashflow metric values by FI computing system 130 may be informed by one or more budgetary or financial goals of the customer, e.g., FI computing system 130 may adjust the amount of excess funds to reflect a budget cap specified by the customer within the corresponding elements of profile data, or to reflect a particular savings goal specified by the customer, as described herein.

Further, and based on the analysis of the obtained subset of the stored elements of decomposed field data and the generated cashflow metric values, FI computing system 130 may perform any of the exemplary processes described herein to compute a real-time indicator of a current financial health and financial well-being of the customer (e.g., in step 614 of FIG. 6). The real-time indicator may include a numerical score (e.g., real-time, numerical score), and in some instances, the numerical score may characterize of a likelihood of an occurrence of one or more events indicating, to the financial institution, the financial health and well-being of the customer. For example, the one or more events may be associated with amount of excess funds available within the customer's financial accounts, and the numerical score may range from zero to unity, with a score of unity indicating a maximum of financial health and well-being (e.g., an occurrence of a maximum of excess funds), a score of zero indicating a minimum of financial health and well-being (e.g., an occurrence of deficit in excess funds), and a score of 0.5 indicating a balance between the customer's daily earning and expected daily payments (e.g., an occurrence an absence of excess funds). In other instances, the numerical score associated with the real-time indicator may also characterize the financial health and well-being of the customer in relation to a determine adherence to one or more customer-specified financial or savings goals (e.g., an occurrence of a corresponding event, etc.) characterized within customer profile data 140B (e.g., a score of unity may indicate complete compliant with a specified budget, while a score of zero may indicate a minimum compliance).

Referring back to FIG. 6, FI computing system 130 may perform any of the exemplary processes described herein to generate notification data that includes, among other things, the real-time indicator of the customer's financial health and well-being, and all or a selected portion of the customer- and group-specific values of the transactional metrics and the cashflow metric values, and transmit the generated notification data across a communications network to the customer device, such as client device 102 (e.g., in step 616 of FIG. 6). In some instances, executed mobile banking application 108 at client device 102 may process the response and perform operations that present, within a digital interface (e.g., notification interface 420), one or more graphical representations of the real-time indicator and portions of the transactional or cashflow metric values. Exemplary process 600 may then be complete in step 618.

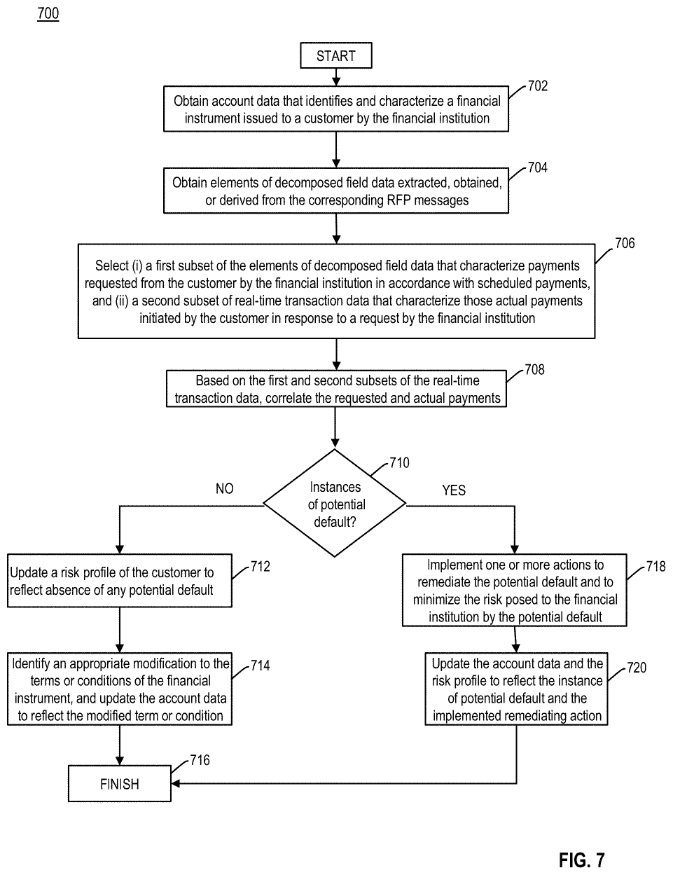

FIG. 7 is a flowchart of an exemplary process 700 for managing customer risk based on real-time-payment (RTP) messages formatted and structured in accordance with one or more standardized data-exchange protocols, in accordance with some exemplary embodiments. For example, one or more computing systems associated with a financial institution, such as FI computing system 130, may perform one or more of the exemplary steps of exemplary process 700. Referring to FIG. 7, FI computing system 130 may obtain, from a data repository (e.g., customer data store 140), elements of account data that identify and characterize a financial instrument, such a credit card account, issued to a customer by the financial institution (e.g., in step 702). In some instances, the account data may include the unique customer identifier assigned to the customer by the financial institution, an identifier of the credit card account (e.g., a tokenized account number, etc.), a current balance and status of the credit card account, a scheduled payment frequency (e.g., daily, weekly, bi-monthly, or monthly), and one or more term and conditions of the issued credit card account (e.g., an interest rate, a minimum monthly payment, a credit limit, etc.).

FI computing system 130 may also obtain the elements of decomposed field data extracted, obtained, or derived from the corresponding RFP messages received or intercepted by the FI computing system 130 (e.g., in step 704 of FIG. 7). Based on the customer identifier and the identifier of the credit card account, the FI computing system may select (i) a first subset of the real-time transaction data that characterize payments requested from the customer by the financial institution in accordance with the scheduled payment frequency, and (ii) a second subset of real-time transaction data that characterize those actual payments initiated by the customer in response to one or more requests by the financial institution (e.g., in step 706 of FIG. 7). Each element of the selected first subset of the elements of decomposed field data may, for example, identify a payment date and a payment amount associated with a corresponding one of the requested payments. Further, each element of selected second subset of the elements of decomposed field data may include an actual payment date (e.g., a date on which the customer approved the real-time payment), an actual payment amount, and an identifier of the corresponding one of the requested payments associated with that actual payment.

In some examples, FI computing system 130 may analyze each of the elements of the first and second subsets of the elements of decomposed field data, and perform operations that correlate each of the payments requested by the financial institution (e.g., as specified by the elements of the first subset) with either (i) one or more of the actual payments approved and initiated by the customer or (ii) an absence of any actual payment approved or submitted by the customer (e.g., also in step 708 of FIG. 7). Based on the analysis of the elements of the first and second subsets of the real-time transaction data, and on the correlation of the requested and actual payments, FI computing system 130 may determine whether the elements of decomposed field data include any instances of potential default on the credit card account by the customer (e.g., in step 710 of FIG. 7) In some instances, the financial institution may define the instance of potential default in accordance with one or more internal guidelines, e.g., when the customer misses two or more successive payments, or approves two or more successive incomplete payments, etc.

For example, FI computing system 130 may perform operations that correlate each of the payments requested by the financial institution with one or more actual payments approved and initiated by the user (e.g., in step 708 of FIG. 7). FI computing system 130 may perform additional operations to determine that an aggregate payment amount associated with each of the one or more actual payments is equivalent to a requested payment amount associated with corresponding one of the requested payments, and that the customer submitted that aggregate payment amount on or before the requested payment date of the corresponding one of the requested payments (e.g., in step 710 of FIG. 7). As such, and based on these determinations, FI computing system 130 may determine that the real-time transaction data associated with the customer indicates no instances of potential default on the credit card account (e.g., in step 710; NO). Alternatively, based on the correlation of the requested and actual payments, FI computing system 130 may identify two or more missed payments, two or more incomplete payments (e.g., when the aggregate payment amount is less than the requested amount), or combinations thereof. In some instances, the FI computing system may determine, in step 4, that the real-time transaction associated with the customer indicates a potential instance of default on the credit card account (e.g., in step 710; YES).

In some examples, and as described herein, many customers of the financial institution, including micro-business customers and gig employees, may transition from scheduled monthly payments on certain existing obligations, such as the credit card account described herein, to scheduled payments at more granular temporal intervals, such as daily payments. By transitioning to scheduled payments at more granular temporal intervals, certain of the exemplary processes described herein may enable the financial institution to identify potential defaults, and to implement any remediating actions, early in a potential default cycle. For instance, through a transition to daily scheduled payments on the credit card payment, certain of these exemplary processes may enable the FI computing system may be capable of detecting a potential default over a span of two days (i.e., the two missed payments), as opposed to two months for conventional, monthly payments on the credit card account.

Referring back to FIG. 7, if FI computing system 130 were to determine that the real-time transaction data associated with the customer indicates no instances of potential default (e.g., in step 710; NO), FI computing system 130 may perform operations that load a risk profile (e.g., risk profile data 318C) associated with the customer, and update portions of the customer's risk profile to reflect the absence of any potential default on the credit card account (e.g., in step 712 of FIG. 7). Further, FI computing system 130 may perform additional operations that identify a modification (if any) to the terms of the credit card account that would be appropriate to the updated risk profile of the customer and to certain of the cashflow metric values and the transactional metric values of the customer, and that update the account data associated with the credit card account to reflect the modified terms and one or more values of the cashflow metrics (e.g., in step 714 of FIG. 7). Examples of these modifications to the terms of the credit card account may include, but are not limited to, a reduction in an interest rate or an increase in an amount of credit available to the customer. The exemplary process may then be completed in step 716.

Alternatively, if the FI computing system were to determine that the real-time transaction associated with the customer indicates the potential instance of default (e.g., step 710; YES), FI computing system 130 may implement one or more actions to remediate the default and to reduce, or minimize, the risk posed to the financial institution by the customer's default (e.g., in step 716 of FIG. 7). Examples of these remediating actions may include flagging the credit card account for additional actions by a collections department of the financial institution, generating and transmitting a notification of the potential default to a customer device, and modifying the terms of the credit card to reflect the instance of potential default. Further, the modifications may include, but are not limited to, reducing the amount of credit available to the customer, increasing the interest rate associated with the credit card account, and placing a temporary hold on an approval of any purchase transactions involving the credit card account.

In some instances, FI computing system 130 may update the account data associated with the credit card account to reflect the instance of potential default and the implemented remediating action, such as the modification to the terms of the credit card account (e.g., in step 718 of FIG. 7). FI computing system 130 may also perform any of the exemplary processes described herein to load the risk profile of the customer, and to update that risk profile to identify the instance of potential default and note the remediating actions implemented by FI computing system 130 (e.g., also in step 718 of FIG. 7). The exemplary process may then be complete at step 716.

### C. Exemplary Hardware and Software Implementations

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including, but not limited to, decomposition engine 146, analytical engine 148, notification engine 150, real-time payment engine 216, remittance analysis engine 336, transactional metric analysis module 316, cashflow metric analysis module 320, profile analysis module 322, request processing module 344, extraction module 414, interface element generation module 416, merchant application 106, and mobile banking application 108, can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, such as user 101, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. An apparatus comprising:
a communications interface;
a memory storing instructions; and
at least one processor coupled to the communications interface and to the memory, the at least one processor being configured to execute the instructions to:
obtain first elements of decomposed message data, the first elements of decomposed message data being associated with exchanges of data involving a first counterparty and characterizing real-time payments requested by or from the first counterparty during a first temporal interval;
based on the first elements of decomposed message data, determine a value of a plurality of parameters that characterize the first counterparty during the first temporal interval, and based on the first elements of decomposed message data and on the parameter values, generate output data indicative of a likelihood of an occurrence of an event during at least one of the first temporal interval or a second temporal interval; and
transmit, via the communications interface, notification data to a device operable by the first counterparty, the notification data comprises at least a portion of the output data, and the notification data causing an application program executed at the device to present the portion of the output data within a digital interface.

2. The apparatus of claim 1, wherein:
the notification data further comprises at least one of the parameter values; and
the notification data further causes the application program executed at the device to present a graphical representation of the at least one parameter value within the digital interface.

3. The apparatus of claim 1, wherein:
the output data comprises a numerical score indicative of the likelihood of the occurrence of the event during the at least one of the first or second temporal intervals;
the notification data further causes the application program executed at the device to present a graphical representation of the numerical score within the digital interface.

4. The apparatus of claim 1, wherein the at least one processor is further configured to execute the instructions to obtain second elements of decomposed message data, the second elements of decomposed message data being associated with exchanges of data involving second counterparties during the first temporal interval, and the one or more second counterparties being associated with the first counterparty.

5. The apparatus of claim 4, wherein the at least one processor is further configured to execute the instructions to:
obtain the value of a first one of the parameters associated with the first counterparty;
based on the second elements of decomposed message data, determine an aggregate value of the first parameter associated with the second counterparties during the first temporal interval;
generate elements of comparative data based on a comparison between the first parameter value associated with the first counterparty and the aggregate parameter value associated with the second counterparty; and
generate the output data based on the elements of decomposed message data, the parameter values, and the comparative data.

6. The apparatus of claim 1, wherein the event is associated with a product held by the first counterparty, and the output data is indicative of the likelihood of the occurrence of the event during the second temporal interval, the second temporal interval being disposed subsequent to the first interval.

7. The apparatus of claim 1, wherein the at least one processor is further configured to execute the instructions to:
obtain, from the memory, elements of product data associated product, the elements of product data comprising a term or condition of the product;
perform operations that modify the term or condition in accordance with the output data, and generate modified product data that includes the modified term or condition; and
store the modified product data within the memory.

8. The apparatus of claim 1, wherein the at least one processor is further configured to execute the instructions to:
apply a trained machine learning or artificial intelligence process to an input dataset that includes at least a portion of the elements of decomposed message data and the parameter values; and
based on the application of the trained machine learning or artificial intelligence process to the input dataset, generate the output data indicative of the likelihood of the occurrence of the event during the at least one of the first or second temporal intervals.

9. The apparatus of claim 1, wherein the at least one processor is further configured to execute the instructions to:
receive, via the communications interface, a message associated with an additional exchange of data involving at least one of the first or second counterparties, the message comprising elements of message data disposed within corresponding message fields, and the message data characterizing a real-time payment requested by the at least one of the first or second counterparties;
obtain, from the memory, mapping data associated with the message fields of the message;
perform operations that obtain additional elements of the decomposed message data from corresponding ones of the message fields based on the mapping data; and
store the elements of the message data within the memory.

10. The apparatus of claim 9, wherein:
the message comprises a request-for-payment message, the message fields of the request-for-payment message being structured in accordance with a standardized data-exchange protocol; and
elements of the mapping data identify corresponding ones of the elements of the message data and corresponding ones of the message fields.

11. A computer-implemented method, comprising:
obtaining first elements of decomposed message data using at least one processor, the first elements of decomposed message data being associated with exchanges of data involving a first counterparty and characterizing real-time payments requested by or from the first counterparty during a first temporal interval;
based on the first elements of decomposed message data, determining, using the at least one processor, a value of a plurality of parameters that characterize the first counterparty during the first temporal interval, and based on the first elements of decomposed message data and on the parameter values, generating, using the at least one processor, output data indicative of a likelihood of an occurrence of an event during at least one of the first temporal interval or a second temporal interval; and
transmitting, using the at least one processor, notification data to a device operable by the first counterparty, the notification data comprising at least a portion of the output data, and the notification data causing an application program executed at the device to present the portion of the output data within a digital interface.

12. The computer-implemented method of claim 11, wherein:
the output data comprises a numerical score indicative of the likelihood of the occurrence of the event during the at least one of the first or second temporal intervals;
the notification data further comprises at least one of the parameter values; and
the notification data further causes the application program executed at the device to present a first graphical representation of the numerical score within the digital interface and a second graphical representative of the at least one parameter value within the digital interface.

13. The computer-implemented method of claim 11, further comprising obtaining, using the at least one processor, second elements of decomposed message data, the second elements of decomposed message data being associated with exchanges of data involving second counterparties during the first temporal interval, the one or more second counterparties being associated with the first counterparty.

14. The computer-implemented method of claim 13, wherein:
the computer-implemented method further comprises:
obtaining, using the at least one processor, the value of a first one of the parameters associated with the first counterparty;
based on the second elements of decomposed message data, determining, using the at least one processor, an aggregate value of the first parameter associated with the second counterparties during the first temporal interval; and
generating, using the at least one processor, elements of comparative data based on a comparison between the first parameter value associated with the first counterparty and the aggregate parameter value associated with the second counterparty; and
the generating comprises generating the output data based on the elements of decomposed message data, the parameter values, and the comparative data.

15. The computer-implemented method of claim 11, wherein the event is associated with a product held by the first counterparty, and the output data is indicative of the likelihood of the occurrence of the event during the second temporal interval, the second temporal interval being disposed subsequent to the first interval.

16. The computer-implemented method of claim 11, further comprising:
obtaining, using the at least one processor, from a data repository, elements of product data associated product, the elements of product data comprising a term or condition of the product;
performing operations, using the at least one processor, that modify the term or condition in accordance with the output data, and that generate modified product data that includes the modified term or condition; and
storing the modified product data within the data repository.

17. The computer-implemented method of claim 11, further comprising:
applying, using the at least one processor, a trained machine learning or artificial intelligence process to an input dataset that includes at least a portion of the elements of decomposed message data and on the parameter values; and
based on the application of the trained machine learning or artificial intelligence process to the input dataset, generating, using the at least one processor, the output data indicative of the likelihood of the occurrence of the event during the at least one of the first or second temporal intervals.

18. The computer-implemented method of claim 11, further comprising:
receiving, using the at least one processor, a message associated with an additional exchange of data involving at least one of the first or second counterparties, the message comprising elements of message data disposed within corresponding message fields, and the message data characterizing a real-time payment requested by the at least one of the first or second counterparties;
obtaining, using the at least one processor, mapping data associated with the message fields of the message;
performing operations, using the at least one processor, that obtain additional elements of the decomposed message data from corresponding ones of the message fields based on the mapping data; and
storing, using the at least one processor, the elements of the message data within a data repository.

19. The computer-implemented method of claim 18, wherein:
the message comprises a request-for-payment message, the message fields of the request-for-payment message being structured in accordance with a standardized data-exchange protocol; and
elements of the mapping data identify corresponding ones of the elements of the message data and corresponding ones of the message fields.

20. A tangible, non-transitory computer-readable medium storing instructions that, when executed by at least one processor, cause the at least one processor to perform a method, comprising:
obtaining, using the at least one processor, elements of decomposed message data, the elements of decomposed message data being associated with exchanges of data involving a counterparty and characterizing real-time payments requested by or from the counterparty during a first temporal interval;
based on the first elements of decomposed message data, determining, using the at least one processor, a value of a plurality of parameters that characterize the counterparty during the first temporal interval, and based on the first elements of decomposed message data and on the parameter values, generating, using the at least one processor, output data indicative of a likelihood of an occurrence of an event during at least one of the first temporal interval or a second temporal intervals; and
transmitting, using the at least one processor, notification data to a device operable by the counterparty, the notification data comprising at least a portion of the output data, and the notification data causing an application program executed at the device to present the portion of the output data within a digital interface.
